(19) United States
(12) Patent Application Publication
(10) Pub. No.: US 2026/0239325 A1
(43) Pub. Date: Aug. 13, 2026

(54) REFERENCE SIGNAL RESOURCES AND SIGNALING FOR BEAMFORMING MODE SWITCHING

(71) Applicant: QUALCOMM Incorporated, San Diego, CA (US)

(72) Inventors: Wooseok NAM, San Diego, CA (US); Narayan PRASAD, Westfield, NJ (US); Mostafa KHOSHNEVISAN, San Diego, CA (US); Tao LUO, San Diego, CA (US); Sony AKKARAKARAN, Poway, CA (US); Junyi LI, Greentown, PA (US)

(21) Appl. No.: 19/050,900

(22) Filed: Feb. 11, 2025

(51) Int. Cl. H04W 72/044; H04L 5/00; H04W 72/232

(52) U.S. Cl. CPC H04W 72/046; H04L 5/0051; H04W 72/232

(57) ABSTRACT

Various aspects of the present disclosure generally relate to wireless communication. In some aspects, a user equipment (UE) may receive configuration information indicating one or more uplink reference signal resource groups associated with an uplink beamforming mode switching capability of the UE. The UE may transmit one or more uplink reference signals based at least in part on the configuration information. The UE may receive feedback based at least in part on transmitting the one or more uplink reference signals. The UE may communicate using a selected uplink beamforming mode that is based at least in part on the feedback. Numerous other aspects are described.

### FIELD OF THE DISCLOSURE

Aspects of the present disclosure generally relate to wireless communication and specifically relate to techniques, apparatuses, and methods associated with reference signal resources and signaling for beamforming mode switching.

### DESCRIPTION OF RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some examples, a wireless communication device may be capable of operating in one or more beamforming modes, such as one or more analog beamforming modes, one or more digital beamforming modes, or one or more hybrid beamforming modes. In analog beamforming, one digital port may be mapped to multiple transmission antenna elements, and amplitude and phase may be adjusted across the multiple antenna elements in the radio frequency (RF) domain to form a transmission beam. In digital beamforming, each digital port (e.g., RF chain) is mapped to a corresponding transmission antenna element, and amplitude and phase may be adjusted across the multiple antenna elements in the digital domain to form a transmission beam. In hybrid beamforming, each digital port may be mapped to more than one antenna element (in a similar manner as analog beamforming) and multiple digital ports (e.g., two or more digital ports) may be used (in a similar manner as digital beamforming).

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include receiving configuration information indicating one or more uplink reference signal resource groups associated with an uplink beamforming mode switching capability of the UE. The method may include transmitting one or more uplink reference signals based at least in part on the configuration information. The method may include receiving feedback based at least in part on transmitting the one or more uplink reference signals. The method may include communicating using a selected uplink beamforming mode that is based at least in part on the feedback.

Some aspects described herein relate to a method of wireless communication performed by a UE. The method may include transmitting capability information indicating an uplink beamforming mode switching capability of the UE. The method may include receiving configuration information from a network node indicating one or more channel state information (CSI) reference signal (CSI-RS) resources based at least in part on the capability information. The method may include communicating using a selected uplink beamforming codeword that is based at least in part on measuring signals associated with the one or more CSI-RS resources.

Some aspects described herein relate to a method of wireless communication performed by a UE. The method may include receiving configuration information indicating CSI-RS resources associated with a downlink beamforming mode switching capability of a network node, and multiple downlink beamforming modes, where each downlink beamforming mode, of the multiple downlink beamforming modes, is associated with a different subset of the CSI-RS resources. The method may include transmitting one or more CSI reports based at least in part on measuring signals associated with the CSI-RS resources.

Some aspects described herein relate to a UE. The UE may include a processing system. The processing system may include one or more processors and one or more code-storing memories coupled with the one or more processors. The processing system may be configured to cause the UE to receive configuration information indicating one or more uplink reference signal resource groups associated with an uplink beamforming mode switching capability of the UE. The processing system may be configured to cause the UE to transmit one or more uplink reference signals based at least in part on the configuration information. The processing system may be configured to cause the UE to receive feedback based at least in part on transmitting the one or more uplink reference signals. The processing system may be configured to cause the UE to communicate using a selected uplink beamforming mode that is based at least in part on the feedback.

Some aspects described herein relate to a UE. The UE may include a processing system. The processing system may include one or more processors and one or more code-storing memories coupled with the one or more processors. The processing system may be configured to cause the UE to transmit capability information indicating an uplink beamforming mode switching capability of the UE. The processing system may be configured to cause the UE to receive configuration information from a network node indicating one or more CSI-RS resources based at least in part on the capability information. The processing system may be configured to cause the UE to communicate using a selected uplink beamforming codeword that is based at least in part on measuring signals associated with the one or more CSI-RS resources.

Some aspects described herein relate to a UE. The UE may include a processing system. The processing system may include one or more processors and one or more code-storing memories coupled with the one or more processors. The processing system may be configured to cause the UE to receive configuration information indicating CSI-RS resources associated with a downlink beamforming mode switching capability of a network node, and multiple downlink beamforming modes, where each downlink beamforming mode, of the multiple downlink beamforming modes, is associated with a different subset of the CSI-RS resources. The processing system may be configured to cause the UE to transmit one or more CSI reports based at least in part on measuring signals associated with the CSI-RS resources.

Some aspects described herein relate to a non-transitory computer-readable medium that stores a set of instructions for wireless communication by a UE. The set of instructions, when executed by one or more processors of the UE, may cause the UE to receive configuration information indicating one or more uplink reference signal resource groups associated with an uplink beamforming mode switching capability of the UE. The set of instructions, when executed by one or more processors of the UE, may cause the UE to transmit one or more uplink reference signals based at least in part on the configuration information. The set of instructions, when executed by one or more processors of the UE, may cause the UE to receive feedback based at least in part on transmitting the one or more uplink reference signals. The set of instructions, when executed by one or more processors of the UE, may cause the UE to communicate using a selected uplink beamforming mode that is based at least in part on the feedback.

Some aspects described herein relate to a non-transitory computer-readable medium that stores a set of instructions for wireless communication by a UE. The set of instructions, when executed by one or more processors of the UE, may cause the UE to transmit capability information indicating an uplink beamforming mode switching capability of the UE. The set of instructions, when executed by one or more processors of the UE, may cause the UE to receive configuration information from a network node indicating one or more CSI-RS resources based at least in part on the capability information. The set of instructions, when executed by one or more processors of the UE, may cause the UE to communicate using a selected uplink beamforming codeword that is based at least in part on measuring signals associated with the one or more CSI-RS resources.

Some aspects described herein relate to a non-transitory computer-readable medium that stores a set of instructions for wireless communication by a UE. The set of instructions, when executed by one or more processors of the UE, may cause the UE to receive configuration information indicating CSI-RS resources associated with a downlink beamforming mode switching capability of a network node, and multiple downlink beamforming modes, where each downlink beamforming mode, of the multiple downlink beamforming modes, is associated with a different subset of the CSI-RS resources. The set of instructions, when executed by one or more processors of UE, may cause the UE to transmit one or more CSI reports based at least in part on measuring signals associated with the CSI-RS resources.

Some aspects described herein relate to an apparatus for wireless communication. The apparatus may include means for receiving configuration information indicating one or more uplink reference signal resource groups associated with an uplink beamforming mode switching capability of the apparatus. The apparatus may include means for transmitting one or more uplink reference signals based at least in part on the configuration information. The apparatus may include means for receiving feedback based at least in part on transmitting the one or more uplink reference signals. The apparatus may include means for communicating using a selected uplink beamforming mode that is based at least in part on the feedback.

Some aspects described herein relate to an apparatus for wireless communication. The apparatus may include means for transmitting capability information indicating an uplink beamforming mode switching capability of the apparatus. The apparatus may include means for receiving configuration information from a network node indicating one or more CSI-RS resources based at least in part on the capability information. The apparatus may include means for communicating using a selected uplink beamforming codeword that is based at least in part on measuring signals associated with the one or more CSI-RS resources.

Some aspects described herein relate to an apparatus for wireless communication. The apparatus may include means for receiving configuration information indicating CSI-RS resources associated with a downlink beamforming mode switching capability of a network node, and multiple downlink beamforming modes, where each downlink beamforming mode, of the multiple downlink beamforming modes, is associated with a different subset of the CSI-RS resources. The apparatus may include means for transmitting one or more CSI reports based at least in part on measuring signals associated with the CSI-RS resources.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIGS. 3A-3D are diagrams illustrating examples associated with beamforming architecture and beamforming modes.

FIGS. 4A-4E are diagrams of examples associated with reference signal resources and signaling for beamforming mode switching.

FIG. 5 is a diagram illustrating an example process performed, for example, at a user equipment (UE) or an apparatus of a UE.

FIG. 6 is a diagram illustrating another example process performed, for example, at a UE or an apparatus of a UE.

FIG. 7 is a diagram illustrating another example process performed, for example, at a UE or an apparatus of a UE.

FIG. 8 is a diagram of an example apparatus for wireless communication.

FIG. 9 is a diagram of another example apparatus for wireless communication.

### DETAILED DESCRIPTION

In some examples, a wireless communication device may be capable of operating in one or more beamforming modes, such as one or more analog beamforming modes, one or more digital beamforming modes, or one or more hybrid beamforming modes. In analog beamforming, one digital port may be mapped to multiple transmission antenna elements, and amplitude and phase may be adjusted across the multiple antenna elements in the radio frequency (RF) domain to form a transmission beam. In digital beamforming, each digital port (e.g., RF chain) is mapped to a corresponding transmission antenna element, and amplitude and phase may be adjusted across the multiple antenna elements in the digital domain to form a transmission beam. In hybrid beamforming, each digital port may be mapped to more than one antenna element (in a similar manner as analog beamforming) and multiple digital ports (e.g., two or more digital ports) may be used (in a similar manner as digital beamforming).

In some examples, a wireless communication device may be capable of switching between beamforming modes (e.g., between an analog beamforming mode and a hybrid beamforming mode) or may be capable of performing antenna selection or adaptation. For example, when a user equipment (UE) is located at a cell edge, the UE or a network node may combine antenna elements in an analog domain to achieve a higher beamforming gain. For example, a device operating in a hybrid beamforming mode associated with four digital ports and two dual-polarity M×N arrays may switch to operating in an analog beamforming mode associated with two digital ports with a single dual-polarity 2M×N array. Moreover, a UE or a network node associated with N digital ports may use only a subset of the N digital ports in certain situations, such as for saving power or reducing transmission or reception complexity. Similarly, for power saving, a UE or a network node may combine some antenna elements in the analog domain in order to reduce a quantity of digital ports/RF chains at the device.

In some examples, in order to switch between beamforming modes (e.g., one or more analog beamforming modes, one or more digital beamforming modes, or one or more hybrid beamforming modes), a wireless communication device (e.g., a UE or a network node) may be capable of activating/deactivating RF chains, antenna elements, or a combination thereof. For example, a device may be capable of activating/deactivating RF chains, with each active RF chain being capable of performing analog beamforming over a subset of selected antenna elements, and with power being split to drive the selected antenna elements (such as when each RF chain is associated with a corresponding power amplifier (PA)). In some other examples, each selected antenna element may be driven by its own PA.

However, certain measurement resources and procedures may be needed in order to enable the various devices to select an optimal beamforming mode, such as to select an optimal subset or quantity of activated RF chains/digital ports used by the device, to select an optimal analog beamforming (ABF) span (e.g., a quantity of antenna elements with independent analog phase or amplitude control that a transmit RF chain is connected to) used by the device, optimal power-related attributes used by the device (e.g., total power, maximum power per RF chain, pilot-to-data power offsets, or similar power-related attributes), or other parameters associated with a beamforming mode. Without such measurement resources and procedures, a wireless communication device may operate in a sub-optimal beamforming mode, resulting in high consumption of power resources or degraded communication channels, which may result in communication errors and thus high power, computing, and network resource consumption for correcting the communication errors.

Various aspects relate generally to reference signal resources and signaling for beamforming mode switching. Some aspects more specifically relate to resources and procedures to optimize selection of an uplink beamforming mode at a UE or a downlink beamforming mode at a network node. In some aspects, a network node may transmit, and a UE may receive, configuration information indicating one or more uplink reference signal resource groups associated with an uplink beamforming mode switching capability of the UE. The UE may transmit, and the network node may receive, one or more uplink reference signals based at least in part on the configuration information. The UE may receive explicit or implicit feedback based at least in part on transmitting the one or more uplink reference signals, and the UE and the network node may communicate using a selected uplink beamforming mode that is based at least in part on the feedback. In some other aspects, the UE may transmit, and the network node may receive, capability information indicating an uplink beamforming mode switching capability of the UE. The network node may transmit, and the UE may receive, configuration information indicating one or more channel state information (CSI) reference signal (CSI-RS) resources based at least in part on the capability information. The UE and the network node may communicate using a selected uplink beamforming codeword that is based at least in part on measuring signals associated with the one or more CSI-RS resources. In still some other aspects, the network node may transmit, and the UE may receive, configuration information indicating CSI-RS resources associated with a downlink beamforming mode switching capability of the network node and multiple downlink beamforming modes, with each downlink beamforming mode being associated with a different subset of the CSI-RS resources. The UE may transmit, and the network node may receive, one or more CSI reports based at least in part on the UE measuring signals associated with the CSI-RS resources.

Particular aspects of the subject matter described in this disclosure can be implemented to realize one or more of the following potential advantages. In some examples, the described techniques can be used by the UE or the network node to select and communicate using an optimized uplink beamforming mode or an optimized downlink beamforming mode, resulting in power savings at the UE or the network node. In some other examples, the described techniques can be used by the UE or the network node to select and communicate using an optimized beamforming pair, resulting in improved communication channels between the UE and the network node, and thus decreased communication errors associated with UE and network node communications, resulting in reduced power, computing, and network resource consumption otherwise required for correcting the communication errors.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning RF sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

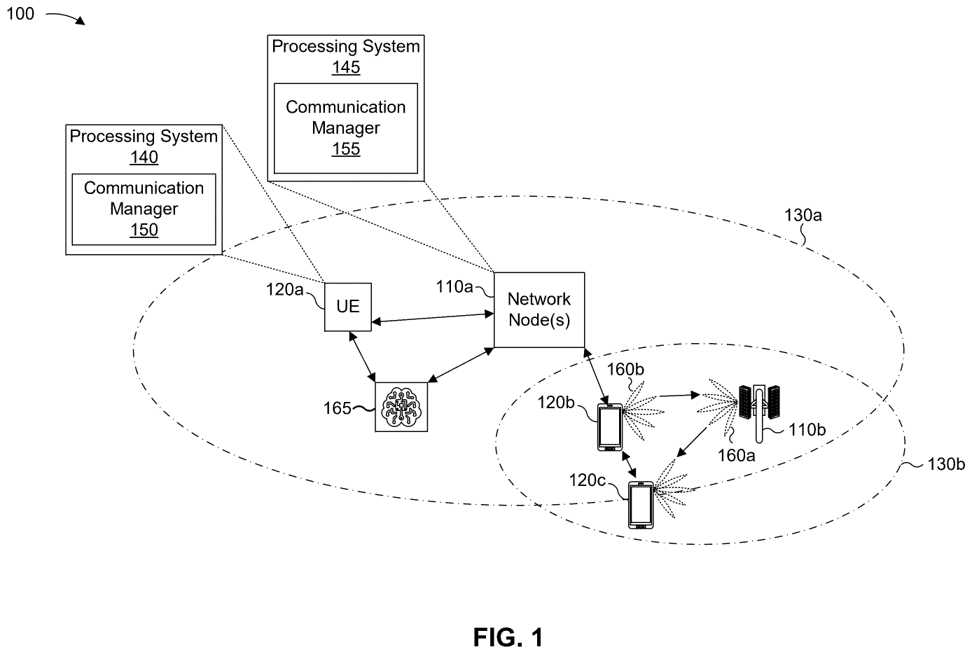

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI-RS, among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

An antenna panel, an antenna group, or an antenna array may include one or more antenna elements (within a single housing or multiple housings), one or more coplanar antenna elements, one or more non-coplanar antenna elements, or one or more antenna elements coupled with one or more transmission or reception components, such as the processing system 140 or the processing system 145. “Antenna element” refers to single radiating (for example, transmitting) or receiving point included in an antenna array. An antenna array may also be referred to as a “sub-array.” An antenna array may include one or more antenna elements where each antenna element is configured as a single unit for radiating (for example, transmitting) or receiving. In some examples, each of the antenna elements of an antenna may include one or more sub-elements for radiating or transmitting or receiving RF signals. A “sub-element” refers to an individual component (e.g., an individually controllable component) within an antenna element, such as an individual radiating unit. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere constructively or destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. In some examples, antenna elements may be individually selected or deselected for directional transmission of a signal (or signals) by controlling amplitudes of one or more corresponding amplifiers or phases of the signal(s) to form one or more beams. The shape of a beam (such as the amplitude, width, or presence of side lobes) or the direction of a beam (such as an angle of the beam relative to a surface of an antenna array) can be dynamically controlled by modifying the phase shifts, phase offsets, or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Advantages of using a larger number of antenna elements may include providing increased control over parameters for beam generation relative to a smaller number of antenna elements, whereas advantages of using a smaller number of antenna elements may include reducing implementation complexity, or reduced power consumption compared to use of a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

Advancements in antenna designs may be driven by the need for faster data rates, lower latency, or more reliable connectivity in advanced/next-generation systems, such as 6G systems, massive multiple-input multiple-output (massive MIMO) systems, among other examples. For example, the wireless communication network 100 may operate using higher frequency bands, such as millimeter wave frequencies or terahertz (THz) frequencies, which enable faster data transmissions and increased bandwidth. To enable UEs 120 and network nodes 110 to communicate using these higher frequency bands, antennas (or antenna elements) of the UEs 120 and network nodes 110 may be configured to address the increased signal attenuation or limited range associated with these higher frequency bands. For example, a UE 120 or a network node 110 may use advanced beamforming techniques, such as AI/ML-based beamforming techniques (for example, in which an AI/ML model can be used to dynamically adjust beamforming patterns in response to changing network conditions, channel conditions, or UE location, among other examples, to improve signal strength or reduce interference). Additionally, the antennas may have a higher density of antenna elements (e.g., as compared to conventional antenna configurations) to enable more precise beam steering or to increase the quantity of independent beams that can be formed simultaneously using an antenna panel (thereby supporting an increased quantity of simultaneous connections). Additionally, the wireless communication network 100 may include one or more devices that have dynamically configurable antenna panels or antenna elements (for example, for an intelligent reflecting surface (IRS) or a reconfigurable intelligent surface (RIS)) to improve coverage and signal strength.

Further efficiencies in throughput, signal strength, or other signal properties may be achieved through beam refinement. For example, the network node 110 may be capable of communicating with the UE 120 using beams (for example, beam(s) 160a) of different beam widths. In some examples, the network node 110 may be configured to utilize a wider beam (for example, a beam having a larger angular spread) to communicate with the UE 120 when the UE 120 is in motion or for initial beam acquisition because wider coverage may increase the likelihood that the UE 120 remains in coverage of the network node 110 while communicating using the wider beam. Conversely, the network node 110 may use a narrower beam to communicate with the UE 120 when the UE 120 is stationary because the network node 110 can reliably focus coverage on the UE 120 with low or minimal likelihood of the UE 120 moving out of the coverage area of the narrower beam. In some examples, to select a particular beam (for example, from the beam(s) 160a) for communication with a UE 120, the network node 110 may transmit a reference signal, such as an SSB or a CSI-RS, on each of a plurality of beams in a beam-sweeping manner. In some examples, SSBs may be transmitted on wider beams, whereas CSI-RSs may be transmitted on narrower beams. The UE 120 may measure the RSRP or the signal-to-interference-plus-noise ratio (SINR) on each of the beams and transmit a beam measurement report (for example, a Layer 1 (L1) measurement report) to the network node 110 indicating the RSRP or SINR associated with each of one or more of the measured beams. The network node 110 may then select the particular beam for communication with the UE 120 based on the L1 measurement report. In some other examples, when there is channel reciprocity between the uplink and the downlink, the network node 110 may derive the particular beam to communicate with the UE 120 (for example, on both the uplink and downlink) based on uplink measurements of one or more uplink reference signals, such as an SRS, transmitted by the UE 120.

In some examples, a UE 120 or a network node 110 may use an inference model (for example, an AI/ML model) to obtain one or more inferences or predictions for beamforming. An output of the inference model may include a codebook based spatial domain selection or prediction (for example, that indicates one or more predicted measurement values for one or more beams) or a non-codebook based spatial domain selection or prediction (for example, that indicates one or more parameters for a beam, such as a point-direction, an angle of departure (AoD), or an angle of arrival (AoA), among other examples). The UE 120 or the network node 110 may configure one or more antenna elements to form one or more beams in accordance with the output of the inference model.

In some aspects, the UE 120 may include a communication manager 150. As described in more detail elsewhere herein, the communication manager 150 may receive configuration information indicating one or more uplink reference signal resource groups associated with an uplink beamforming mode switching capability of the UE 120; transmit one or more uplink reference signals based at least in part on the configuration information; receive feedback based at least in part on transmitting the one or more uplink reference signals; and communicate using a selected uplink beamforming mode that is based at least in part on the feedback. Additionally, or alternatively, the communication manager 150 may transmit capability information indicating an uplink beamforming mode switching capability of the UE 120; receive configuration information from a network node indicating one or more CSI-RS resources based at least in part on the capability information; and communicate using a selected uplink beamforming codeword that is based at least in part on measuring signals associated with the one or more CSI-RS resources. Additionally, or alternatively, the communication manager 150 may receive configuration information indicating: CSI-RS resources associated with a downlink beamforming mode switching capability of a network node, and multiple downlink beamforming modes, wherein each downlink beamforming mode, of the multiple downlink beamforming modes, is associated with a different subset of the CSI-RS resources; and transmit one or more CSI reports based at least in part on measuring signals associated with the CSI-RS resources. Additionally, or alternatively, the communication manager 150 may perform one or more other operations described herein.

In some aspects, the network node 110 may include a communication manager 155. As described in more detail elsewhere herein, the communication manager 155 may transmit configuration information indicating one or more uplink reference signal resource groups associated with an uplink beamforming mode switching capability of a UE; receive one or more uplink reference signals based at least in part on the configuration information; transmit feedback based at least in part on receiving the one or more uplink reference signals; and communicate using a selected uplink beamforming mode that is based at least in part on the feedback. Additionally, or alternatively, the communication manager 155 may receive capability information indicating an uplink beamforming mode switching capability of a UE; transmit configuration information indicating one or more CSI-RS resources based at least in part on the capability information; and communicate using a selected uplink beamforming codeword that is based at least in part on measured signals associated with the one or more CSI-RS resources. Additionally, or alternatively, the communication manager 155 may transmit configuration information indicating: CSI-RS resources associated with a downlink beamforming mode switching capability of the network node 110, and multiple downlink beamforming modes, wherein each downlink beamforming mode, of the multiple downlink beamforming modes, is associated with a different subset of the CSI-RS resources; and receive one or more CSI reports based at least in part on measuring signals associated with the CSI-RS resources. Additionally, or alternatively, the communication manager 155 may perform one or more other operations described herein.

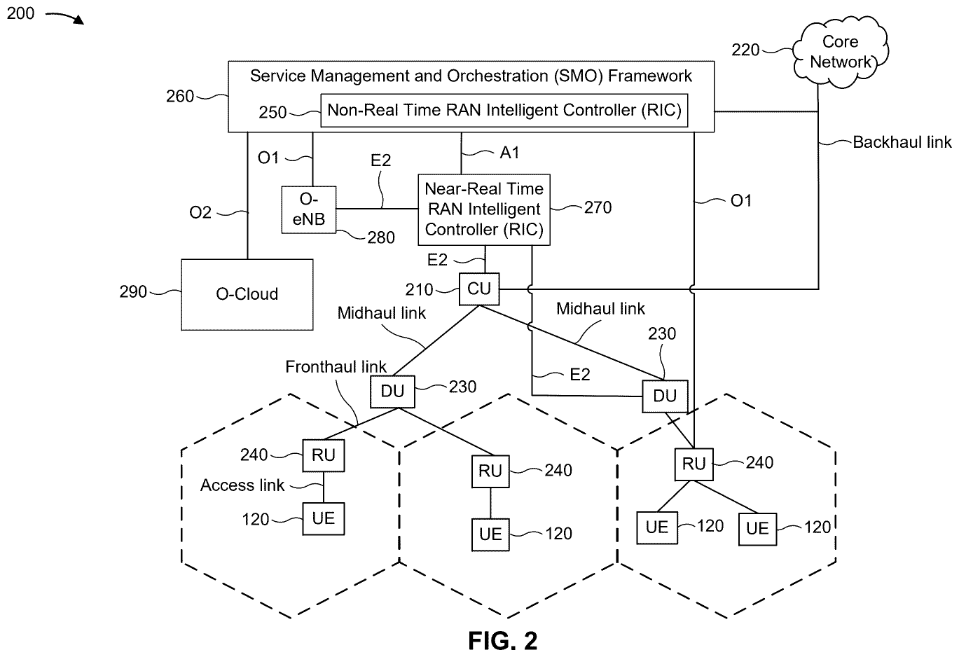

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

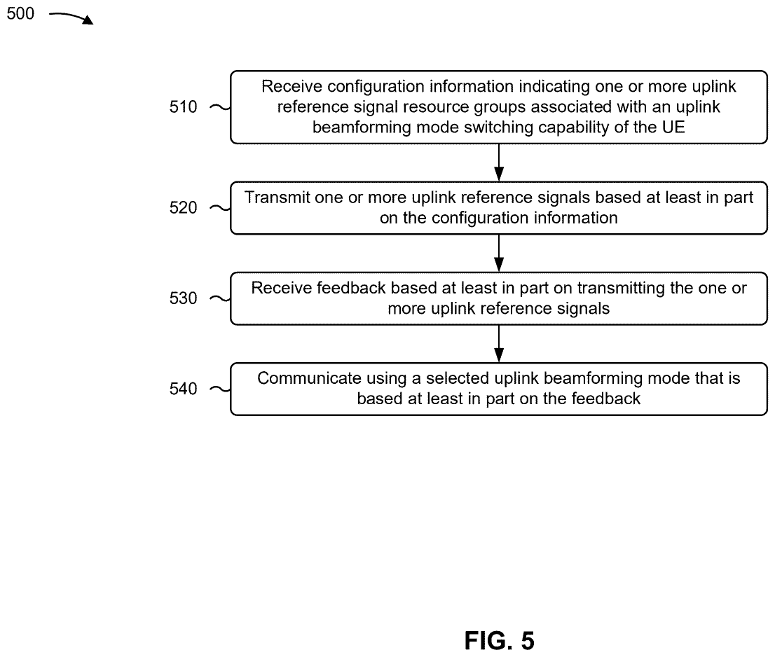

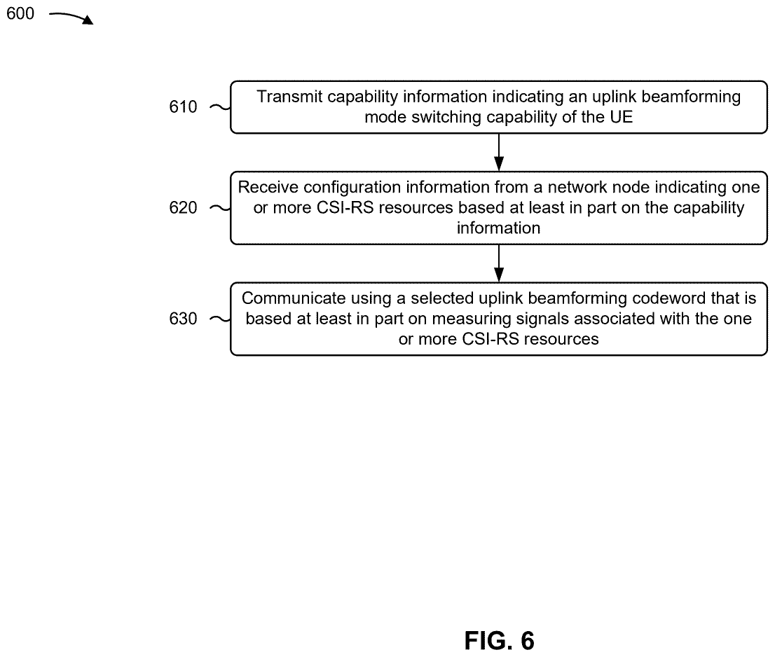

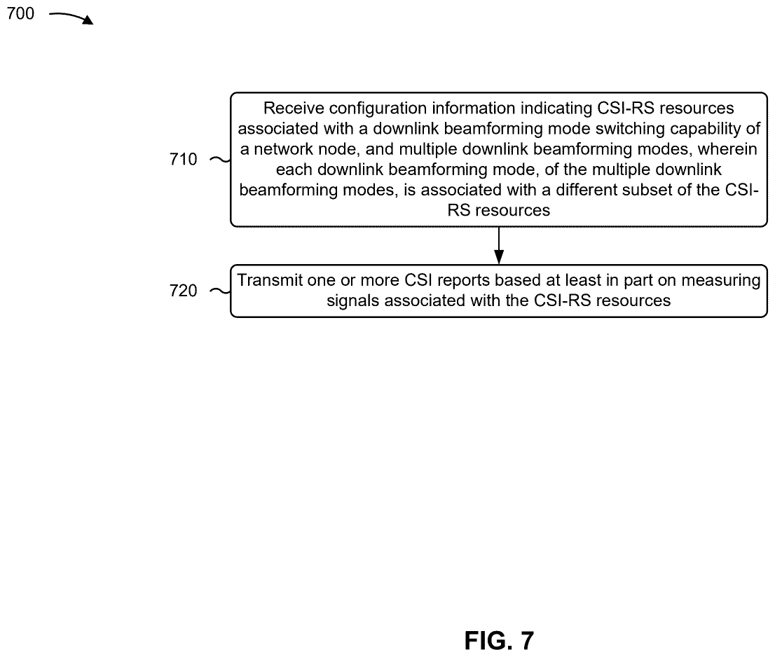

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with reference signal resources and signaling for beamforming mode switching, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, process 700 of FIG. 7, or other processes as described herein. In some examples, executing instructions may include running the instructions, converting the instructions, compiling the instructions, or interpreting the instructions, among other examples.

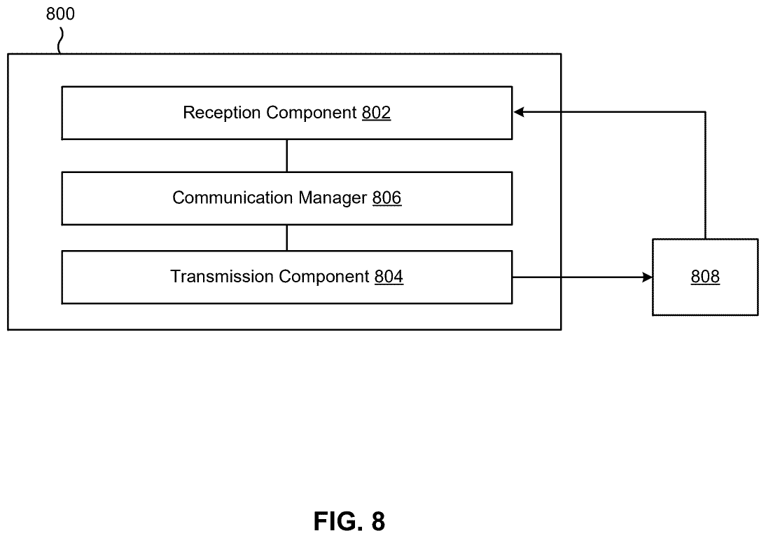

In some aspects, the UE 120 includes means for receiving configuration information indicating one or more uplink reference signal resource groups associated with an uplink beamforming mode switching capability of the UE 120; means for transmitting one or more uplink reference signals based at least in part on the configuration information; means for receiving feedback based at least in part on transmitting the one or more uplink reference signals; or means for communicating using a selected uplink beamforming mode that is based at least in part on the feedback. In some other aspects, the UE 120 includes means for transmitting capability information indicating an uplink beamforming mode switching capability of the UE 120; means for receiving configuration information from a network node indicating one or more CSI-RS resources based at least in part on the capability information; or means for communicating using a selected uplink beamforming codeword that is based at least in part on measuring signals associated with the one or more CSI-RS resources. In some other aspects, the UE 120 includes means for receiving configuration information indicating: CSI-RS resources associated with a downlink beamforming mode switching capability of a network node, and multiple downlink beamforming modes, wherein each downlink beamforming mode, of the multiple downlink beamforming modes, is associated with a different subset of the CSI-RS resources; or means for transmitting one or more CSI reports based at least in part on measuring signals associated with the CSI-RS resources. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

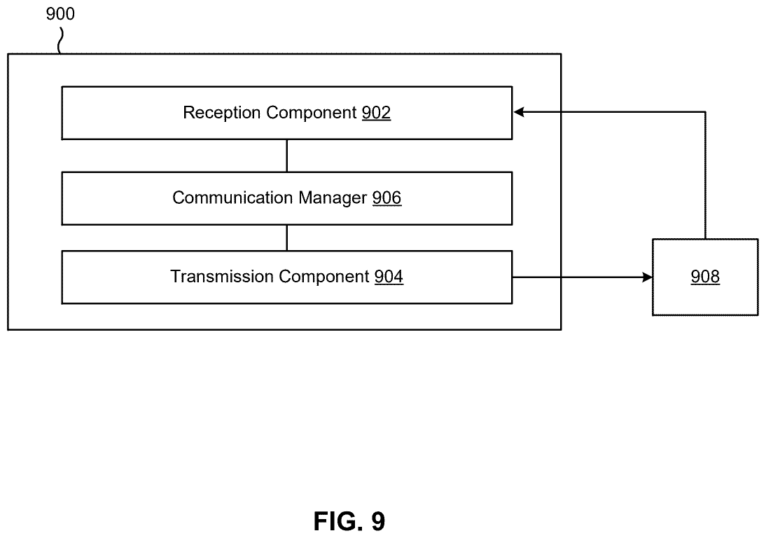

In some aspects, the network node 110 includes means for transmitting configuration information indicating one or more uplink reference signal resource groups associated with an uplink beamforming mode switching capability of a UE; means for receiving one or more uplink reference signals based at least in part on the configuration information; means for transmitting feedback based at least in part on receiving the one or more uplink reference signals; or means for communicating using a selected uplink beamforming mode that is based at least in part on the feedback. In some other aspects, the network node 110 includes means for receiving capability information indicating an uplink beamforming mode switching capability of a UE; means for transmitting configuration information indicating one or more CSI-RS resources based at least in part on the capability information; or means for communicating using a selected uplink beamforming codeword that is based at least in part on measuring signals associated with the one or more CSI-RS resources. In some other aspects, the network node 110 includes means for transmitting configuration information indicating: CSI-RS resources associated with a downlink beamforming mode switching capability of the network node 110, and multiple downlink beamforming modes, wherein each downlink beamforming mode, of the multiple downlink beamforming modes, is associated with a different subset of the CSI-RS resources; or means for receiving one or more CSI reports that are based at least in part on measured signals associated with the CSI-RS resources. The means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

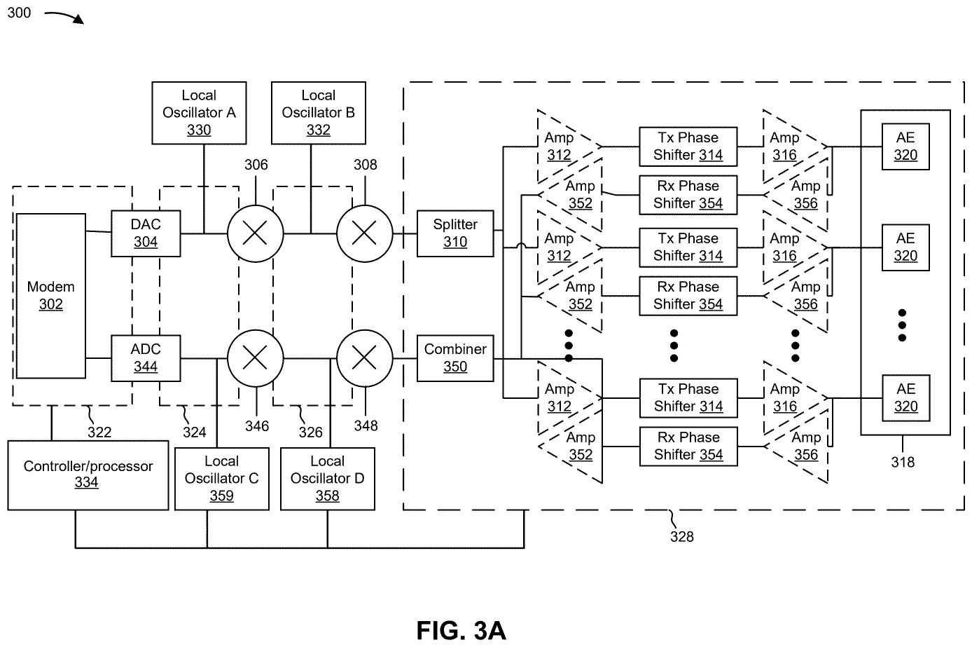

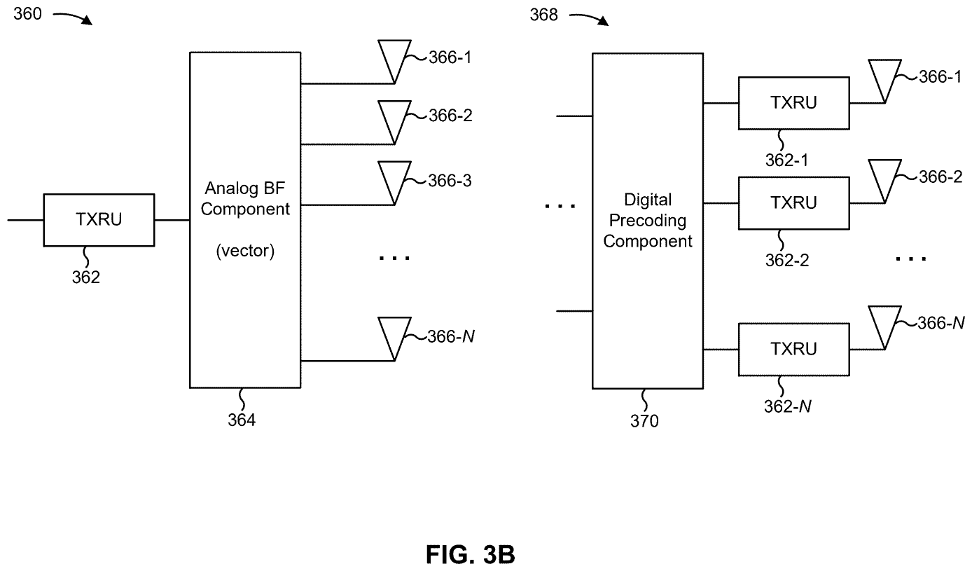

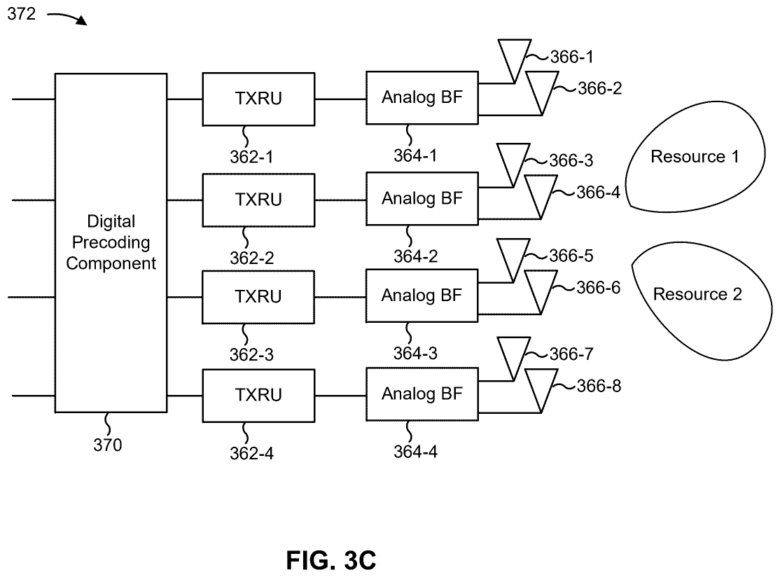

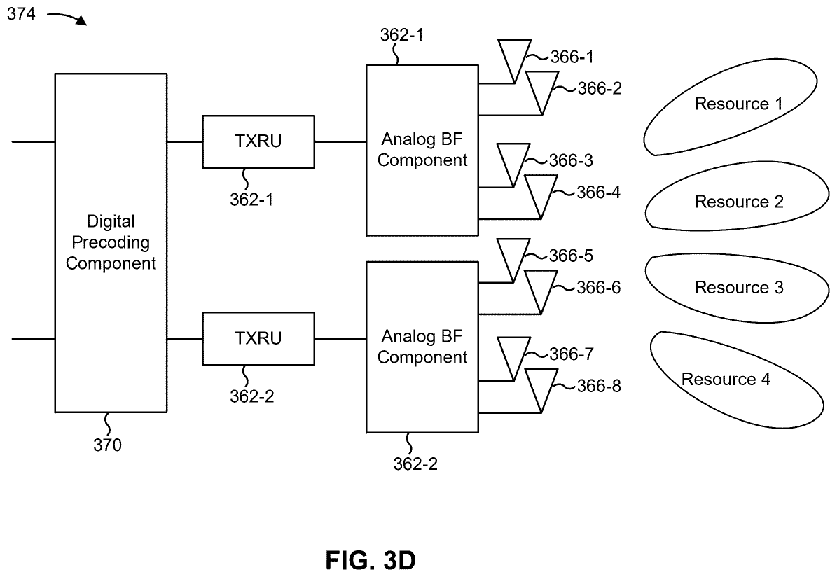

FIGS. 3A-3D are diagrams illustrating examples associated with beamforming architecture and beamforming modes. For example, FIG. 3A is a diagram illustrating an example beamforming architecture 300 that supports beamforming for mmWave communications, among other examples. In some aspects, architecture 300 may implement aspects of wireless communication network 100. In some aspects, architecture 300 may be implemented in a transmitting device (e.g., a first wireless communication device, UE, or network node) or a receiving device (e.g., a second wireless communication device, UE, or network node), as described herein.

Broadly, FIG. 3A is a diagram illustrating example hardware components of a wireless communication device in accordance with certain aspects of the disclosure. The illustrated components may include those that may be used for antenna element selection or for beamforming for transmission of wireless signals. There are numerous architectures for antenna element selection and implementing phase shifting, only one example of which is illustrated here. The architecture 300 includes a modem (modulator/demodulator) 302, a digital to analog converter (DAC) 304, a first mixer 306, a second mixer 308, and a splitter 310. The architecture 300 also includes multiple first amplifiers 312, multiple phase shifters 314, multiple second amplifiers 316, and an antenna array 318 that includes multiple antenna elements 320.

Transmission lines or other waveguides, wires, or traces are shown connecting the various components to illustrate how signals to be transmitted may travel between components. Reference numbers 322, 324, 326, and 328 indicate regions in the architecture 300 in which different types of signals travel or are processed. Specifically, reference number 322 indicates a region in which digital baseband signals travel or are processed, reference number 324 indicates a region in which analog baseband signals travel or are processed, reference number 326 indicates a region in which analog intermediate frequency (IF) signals travel or are processed, and reference number 328 indicates a region in which analog radio frequency (RF) signals travel or are processed. The architecture also includes a local oscillator A 330, a local oscillator B 332, and a controller/processor 334.

Each of the antenna elements 320 may include one or more sub-elements for radiating or receiving RF signals. For example, a single antenna element 320 may include a first sub-element cross-polarized with a second sub-element that can be used to independently transmit cross-polarized signals. The antenna elements 320 may include patch antennas, dipole antennas, or other types of antennas arranged in a linear pattern, a two dimensional pattern, or another pattern. A spacing between antenna elements 320 may be such that signals with a desired wavelength transmitted separately by the antenna elements 320 may interact or interfere (e.g., to form a desired beam). For example, given an expected range of wavelengths or frequencies, the spacing may provide a quarter wavelength, half wavelength, or other fraction of a wavelength of spacing between neighboring antenna elements 320 to allow for interaction or interference of signals transmitted by the separate antenna elements 320 within that expected range.

The modem 302 processes and generates digital baseband signals and may also control operation of the DAC 304, first and second mixers 306, 308, splitter 310, first amplifiers 312, phase shifters 314, or the second amplifiers 316 to transmit signals via one or more or all of the antenna elements 320. The modem 302 may process signals and control operation in accordance with a communication standard such as a wireless standard discussed herein. The DAC 304 may convert digital baseband signals received from the modem 302 (and that are to be transmitted) into analog baseband signals. The first mixer 306 upconverts analog baseband signals to analog IF signals within an IF using a local oscillator A 330. For example, the first mixer 306 may mix the signals with an oscillating signal generated by the local oscillator A 330 to “move” the baseband analog signals to the IF. In some cases, some processing or filtering (not shown) may take place at the IF. The second mixer 308 upconverts the analog IF signals to analog RF signals using the local oscillator B 332. Similar to the first mixer, the second mixer 308 may mix the signals with an oscillating signal generated by the local oscillator B 332 to “move” the IF analog signals to the RF or the frequency at which signals will be transmitted or received. The modem 302 or the controller/processor 334 may adjust the frequency of local oscillator A 330 or the local oscillator B 332 so that a desired IF or RF frequency is produced and used to facilitate processing and transmission of a signal within a desired bandwidth.

In the illustrated architecture 300, signals upconverted by the second mixer 308 are split or duplicated into multiple signals by the splitter 310. The splitter 310 in architecture 300 splits the RF signal into multiple identical or nearly identical RF signals. In other examples, the split may take place with any type of signal, including with baseband digital, baseband analog, or IF analog signals. Each of these signals may correspond to an antenna element 320, and the signal travels through and is processed by amplifiers 312, 316, phase shifters 314, or other elements corresponding to the respective antenna element 320 to be provided to and transmitted by the corresponding antenna element 320 of the antenna array 318. In one example, the splitter 310 may be an active splitter that is connected to a power supply and provides some gain so that RF signals exiting the splitter 310 are at a power level equal to or greater than the signal entering the splitter 310. In another example, the splitter 310 is a passive splitter that is not connected to power supply and the RF signals exiting the splitter 310 may be at a power level lower than the RF signal entering the splitter 310.

After being split by the splitter 310, the resulting RF signals may enter an amplifier, such as a first amplifier 312, or a phase shifter 314 corresponding to an antenna element 320. The first and second amplifiers 312, 316 are illustrated with dashed lines because one or both of them might not be necessary in some aspects. In some aspects, both the first amplifier 312 and second amplifier 316 are present. In some aspects, neither the first amplifier 312 nor the second amplifier 316 is present. In some aspects, one of the two amplifiers 312, 316 is present but not the other. By way of example, if the splitter 310 is an active splitter, the first amplifier 312 may not be used. By way of further example, if the phase shifter 314 is an active phase shifter that can provide a gain, the second amplifier 316 might not be used.

The amplifiers 312, 316 may provide a desired level of positive or negative gain. A positive gain (positive dB) may be used to increase an amplitude of a signal for radiation by a specific antenna element 320. A negative gain (negative dB) may be used to decrease an amplitude or suppress radiation of the signal by a specific antenna element. Each of the amplifiers 312, 316 may be controlled independently (e.g., by the modem 302 or the controller/processor 334) to provide independent control of the gain for each antenna element 320. For example, the modem 302 or the controller/processor 334 may have at least one control line connected to each of the splitter 310, first amplifiers 312, phase shifters 314, or second amplifiers 316 that may be used to configure a gain to provide a desired amount of gain for each component and thus each antenna element 320.

The phase shifter 314 may provide a configurable phase shift or phase offset to a corresponding RF signal to be transmitted. The phase shifter 314 may be a passive phase shifter not directly connected to a power supply. Passive phase shifters might introduce some insertion loss. The second amplifier 316 may boost the signal to compensate for the insertion loss. The phase shifter 314 may be an active phase shifter connected to a power supply such that the active phase shifter provides some amount of gain or prevents insertion loss. The settings of each of the phase shifters 314 are independent, meaning that each can be independently set to provide a desired amount of phase shift or the same amount of phase shift or some other configuration. The modem 302 or the controller/processor 334 may have at least one control line connected to each of the phase shifters 314 and which may be used to configure the phase shifters 314 to provide a desired amount of phase shift or phase offset between antenna elements 320.

In the illustrated architecture 300, RF signals received by the antenna elements 320 are provided to one or more first amplifiers 356 to boost the signal strength. The first amplifiers 356 may be connected to the same antenna arrays 318 (e.g., for time division duplex (TDD) operations). The first amplifiers 356 may be connected to different antenna arrays 318. The boosted RF signal is input into one or more phase shifters 354 to provide a configurable phase shift or phase offset for the corresponding received RF signal to enable reception via one or more Rx beams. The phase shifter 354 may be an active phase shifter or a passive phase shifter. The settings of the phase shifters 354 are independent, meaning that each can be independently set to provide a desired amount of phase shift or the same amount of phase shift or some other configuration. The modem 302 or the controller/processor 334 may have at least one control line connected to each of the phase shifters 354 and which may be used to configure the phase shifters 354 to provide a desired amount of phase shift or phase offset between antenna elements 320 to enable reception via one or more Rx beams.

The outputs of the phase shifters 354 may be input to one or more second amplifiers 352 for signal amplification of the phase shifted received RF signals. The second amplifiers 352 may be individually configured to provide a configured amount of gain. The second amplifiers 352 may be individually configured to provide an amount of gain to ensure that the signals input to combiner 350 have the same magnitude. The amplifiers 352 or 356 are illustrated in dashed lines because they might not be necessary in some aspects. In some aspects, both the amplifier 352 and the amplifier 356 are present. In another aspect, neither the amplifier 352 nor the amplifier 356 are present. In other aspects, one of the amplifiers 352, 356 is present but not the other.

In the illustrated architecture 300, signals output by the phase shifters 354 (via the amplifiers 352 when present) are combined in combiner 350. The combiner 350 in architecture 300 combines the RF signal into a signal. The combiner 350 may be a passive combiner (e.g., not connected to a power source), which may result in some insertion loss. The combiner 350 may be an active combiner (e.g., connected to a power source), which may result in some signal gain. When combiner 350 is an active combiner, it may provide a different (e.g., configurable) amount of gain for each input signal so that the input signals have the same magnitude when they are combined. When combiner 350 is an active combiner, the combiner 350 may not need the second amplifier 352 because the active combiner may provide the signal amplification.

The output of the combiner 350 is input into mixers 348 and 346. Mixers 348 and 346 generally down convert the received RF signal using inputs from local oscillators 358 and 359, respectively, to create intermediate or baseband signals that carry the encoded and modulated information. The output of the mixers 348 and 346 are input into an analog-to-digital converter (ADC) 344 for conversion to digital signals. The digital signals output from ADC 344 are input to modem 302 for baseband processing, such as decoding, de-interleaving, or similar operations.

The architecture 300 is given by way of example only to illustrate an architecture for transmitting or receiving signals. In some cases, the architecture 300 or each portion of the architecture 300 may be repeated multiple times within an architecture to accommodate or provide an arbitrary number of RF chains, antenna elements, or antenna panels. Furthermore, numerous alternate architectures are possible and contemplated. For example, although only a single antenna array 318 is shown, two, three, or more antenna arrays may be included, each with one or more of their own corresponding amplifiers, phase shifters, splitters, mixers, DACs, ADCs, or modems. For example, a single UE may include two, four, or more antenna arrays for transmitting or receiving signals at different physical locations on the UE or in different directions.

Furthermore, mixers, splitters, amplifiers, phase shifters and other components may be located in different signal type areas (e.g., represented by different ones of the reference numbers 322, 324, 326, 328) in different implemented architectures. For example, a split of the signal to be transmitted into multiple signals may take place at the analog RF, analog IF, analog baseband, or digital baseband frequencies in different examples. Similarly, amplification or phase shifts may also take place at different frequencies. For example, in some aspects, one or more of the splitter 310, amplifiers 312, 316, or phase shifters 314 may be located between the DAC 304 and the first mixer 306 or between the first mixer 306 and the second mixer 308. In one example, the functions of one or more of the components may be combined into one component. For example, the phase shifters 314 may perform amplification to include or replace the first or second amplifiers 312, 316. By way of another example, a phase shift may be implemented by the second mixer 308 to obviate the need for a separate phase shifter 314. This technique is sometimes called local oscillator (LO) phase shifting. In some aspects of this configuration, there may be multiple IF to RF mixers (e.g., for each antenna element chain) within the second mixer 308, and the local oscillator B 332 may supply different local oscillator signals (with different phase offsets) to each IF to RF mixer.

The modem 302 or the controller/processor 334 may control one or more of the other components 304 through 359 to select one or more antenna elements 320 or to form beams for transmission of one or more signals. For example, the antenna elements 320 may be individually selected or deselected for transmission of a signal (or signals) by controlling an amplitude of one or more corresponding amplifiers, such as the first amplifiers 312 or the second amplifiers 316. Beamforming includes generation of a beam using multiple signals on different antenna elements, where one or more or all of the multiple signals are shifted in phase relative to each other. The formed beam may carry physical or higher layer reference signals or information. As each signal of the multiple signals is radiated from a respective antenna element 320, the radiated signals interact, interfere (constructive and destructive interference), and amplify each other to form a resulting beam. The shape (such as the amplitude, width, or presence of side lobes) and the direction (such as an angle of the beam relative to a surface of the antenna array 318) can be dynamically controlled by modifying the phase shifts or phase offsets imparted by the phase shifters 314 and amplitudes imparted by the amplifiers 312, 316 of the multiple signals relative to each other. The controller/processor 334 may be located partially or fully within one or more other components of the architecture 300. For example, the controller/processor 334 may be located within the modem 302 in some aspects.

In some examples, a wireless communication device (e.g., using the beamforming architecture shown and described in connection with FIG. 3A, among other examples) may be capable of operating in one or more beamforming modes, such as one or more analog beamforming modes, one or more digital beamforming modes, or one or more hybrid beamforming modes. More particularly, FIG. 3B shows an example 360 associated with an analog beamforming mode. As shown by example 360, an analog beamforming mode may be associated with a transceiver unit (TXRU) 362, an analog beamforming component 364 (sometimes referred to herein as an analog beamforming module), and multiple (e.g., N) antenna elements 366, shown in connection with example 360 as a first antenna element 366-1 through an N^{th} antenna element 366-N. In this regard, for transmission using analog beamforming, one digital port (e.g., one DMRS port or one RF chain) is mapped to N Tx antenna elements 366, and amplitude and phase may be adjusted across the N antenna elements in the RF domain to form a transmission beam. For reception using analog beamforming, one digital port is mapped to N reception antenna elements 366, and signals from the N antenna elements 366 are combined in the RF domain using different weights and phases. As a result, for a small quantity of digital ports, the power consumption and cost for analog beamforming may be lower than for digital beamforming (discussed in more detail below), the effective antenna gain (e.g., array gain) pattern may be strong for some directions and weak for other directions, a beam pairing operation between transmitter and receiver (e.g., beam management) may be needed, and beam resolution may be limited by an analog beamforming codebook.

FIG. 3B further shows an example 368 associated with a digital beamforming mode. As shown by example 368, a digital beamforming mode may be associated with a digital precoding component 370 (sometimes referred to herein as a digital beamforming module) associated with multiple (e.g., M) DMRS ports, multiple (e.g., N) TXRUs 362 (shown in example 368 as a first TXRU 362-1 through an N^{th} TXRU 362-N), and multiple (e.g., N) antenna elements 366 (e.g., the first antenna element 366-1 through the N^{th} antenna element 366-N), each associated with a corresponding one of the multiple TXRUs 362. In this regard, for transmission using digital beamforming, each digital port (e.g., RF chain) is mapped to a transmission antenna element 366, and amplitude and phase may be adjusted across the N antenna elements in the digital domain to form a transmission beam. For reception using digital beamforming, each digital port is mapped to a reception antenna element 366, and signals from the N antenna elements 366 may be combined in the digital domain using different weights and phases. As a result, for a large number of digital ports, the power consumption and cost may be higher for digital beamforming than for analog beamforming, each digital port (e.g., each TXRU 362 or RF port) may be associated with corresponding ADC or digital processing blocks, and optimal transmission and reception beams (e.g., precoders) may be searched using estimated channels, without beam sweeping.

FIG. 3C shows a first example 372 associated with a hybrid beamforming mode. In hybrid beamforming, each digital port may be mapped to more than one antenna element (in a similar manner as described above in connection with analog beamforming) and multiple digital ports (e.g., two or more digital ports) may be used (in a similar manner as described above in connection with digital beamforming). More particularly, as shown by example 372, hybrid beamforming may be associated with a digital precoding component 370, multiple (e.g., four in this example) TXRUs 362 (shown in example 372 as a first TXRU 362-1 through a fourth TXRU 362-4), multiple (e.g., four in this example) analog beamforming components 364 (shown in example 372 as a first analog beamforming component 364-1 through a fourth analog beamforming component 364-4), and multiple (e.g., two in this example) antenna elements 366 associated with each analog beamforming component 364 (for a total of eight antenna elements 366 in example 372, shown as a first antenna element 366-1 through an eight antenna element 366-8).

In some examples, the architecture shown in connection with example 372 may be associated with two wide beam resources (shown as “resource 1” and “resource 2” in example 372), with two antenna elements per digital port and with four digital ports per resource. However, other hybrid beamforming modes may be used to form differently configured resources or a different quantity of resources. For example, FIG. 3D shows a second example 374 associated with a hybrid beamforming mode. In this example, the hybrid beamforming mode may be associated with one digital precoding component 370, two TXRUs 362 (shown in example 374 as a first TXRU 362-1 and a second TXRU 362-2), two analog beamforming components 364 (shown in example 374 as a first analog beamforming component 364-2 and a second analog beamforming component 364-2), and four antenna elements 366 associated with each analog beamforming component 364. In this regard, the architecture shown in connection with example 374 may be associated with four narrow beam resources (shown as “resource 1” through “resource 4” in example 374), with four antenna elements per digital port, and with two digital ports per resource.

In some other examples, a hybrid beamforming mode may be configured in a different manner than those shown in examples 372 and 374. Additionally, or alternatively, a wireless communication device may be capable of switching between beamforming modes (e.g., between an analog beamforming mode and a hybrid beamforming mode) or may be capable of performing antenna selection or adaptation. For example, when a UE is located at a cell edge, the UE or a network node may need to combine antenna elements in the analog domain to achieve a higher beamforming gain. For example, a device operating in a hybrid beamforming mode associated with four digital ports and two dual-polarity M×N arrays may switch to operating in an analog beamforming mode associated with two digital ports with a single dual-polarity 2M×N array. Moreover, a UE or a network node associated with N digital ports may use only a subset of the N digital ports in certain situations, such as for saving power or reducing transmission or reception complexity. Similarly, for power saving, a UE or a network node may choose to combine some antenna elements in the analog domain in order to reduce a quantity of digital ports/RF chains at the device.

In some examples, in order to switch between beamforming modes (e.g., one or more analog beamforming modes, one or more digital beamforming modes, or one or more hybrid beamforming modes), a wireless communication device (e.g., a UE or a network node) may be capable of activating/deactivating RF chains (e.g., TXRUs 362), antenna elements (e.g., antenna elements 366), or a combination thereof. More particularly, in some beamformed transmissions, a device may be capable of activating/deactivating RF chains (e.g., TXRUs 362), with each active RF chain being capable of performing analog beamforming over a subset of selected antenna elements 366, and with power being split to drive the selected antenna elements 366 (e.g., each TXRU 362 may be associated with a corresponding PA, among other examples). In other beamformed transmissions, a device may be capable of activating/deactivating RF chains (e.g., TXRUs 362), with each active RF chain being capable of performing analog beamforming over a subset of selected antenna elements 366, and with each selected antenna element 366 being driven by its own PA, among other examples. For some beamformed receptions, a device may be capable of activating/deactivating RF chains (e.g., TXRUs 362), with each active RF chain being capable of performing analog beamforming using a group of selected antenna elements 366.

However, in order to fully optimize beamforming mode adaptation, measurement resources and procedures may be needed to enable the various devices to select an optimal beamforming mode, such as to select an optimal subset or quantity of activated RF-chains/digital ports used by the device, to select an optimal analog beamforming ABF span (e.g., a quantity of antenna elements with independent analog phase or amplitude control that a transmit RF chain is connected to) used by the device, to select optimal power-related attributes used by the device (e.g., total power, maximum power per RF chain, pilot-to-data power offsets, among other power-related attributes), or to select other parameters associated with a beamforming mode. Without such measurement resources and procedures, a wireless communication device may operate in a sub-optimal beamforming mode, resulting in high consumption of power resources, degraded communication channels, or communication errors resulting in high power, computing, and network resource consumption for correcting the communication errors.

Some aspects and techniques described herein enable reference signal resources and signaling for beamforming mode switching. In some aspects, a network node may transmit, and a UE may receive, configuration information indicating one or more uplink reference signal resource groups associated with an uplink beamforming mode switching capability of the UE. The UE may thus transmit, and the network node may receive, one or more uplink reference signals based at least in part on the configuration information. The UE may receive explicit or implicit feedback based at least in part on transmitting the one or more uplink reference signals, and the UE and the network node may communicate using a selected uplink beamforming mode that is based at least in part on the feedback. In some other aspects, the UE may transmit, and the network node may receive, capability information indicating an uplink beamforming mode switching capability of the UE. The network node may transmit, and the UE may receive, configuration information indicating one or more CSI-RS resources based at least in part on the capability information. The UE and the network node may communicate using a selected uplink beamforming codeword that is based at least in part on measuring signals associated with the one or more CSI-RS resources. In still some other aspects, the network node may transmit, and the UE may receive, configuration information indicating CSI-RS resources associated with a downlink beamforming mode switching capability of a network node, and multiple downlink beamforming modes, each associated with a different subset of the CSI-RS resources. The UE may transmit, and the network node may receive, one or more CSI reports based at least in part on the UE measuring signals associated with the CSI-RS resources. As a result, the UE and the network node may communicate using optimized uplink beamforming modes or downlink beamforming modes, resulting in power savings at the various devices, improved communication channels, or decreased communication errors, and thus reduced power, computing, and network resource consumption otherwise required for correcting the communication errors.

As indicated above, FIGS. 3A-3D are provided as examples. Other examples may differ from what is described with regard to FIGS. 3A-3D.

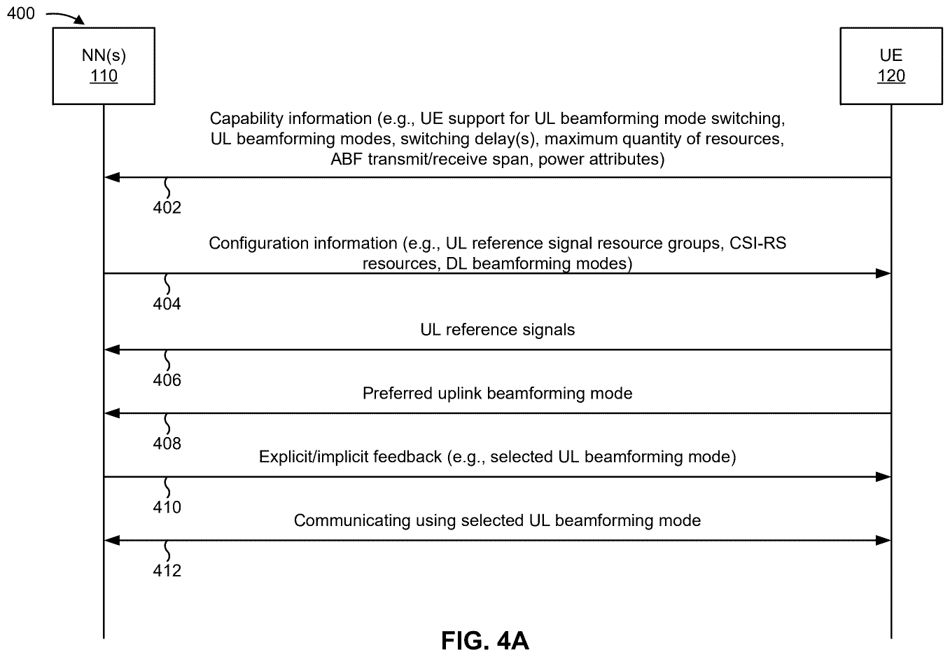

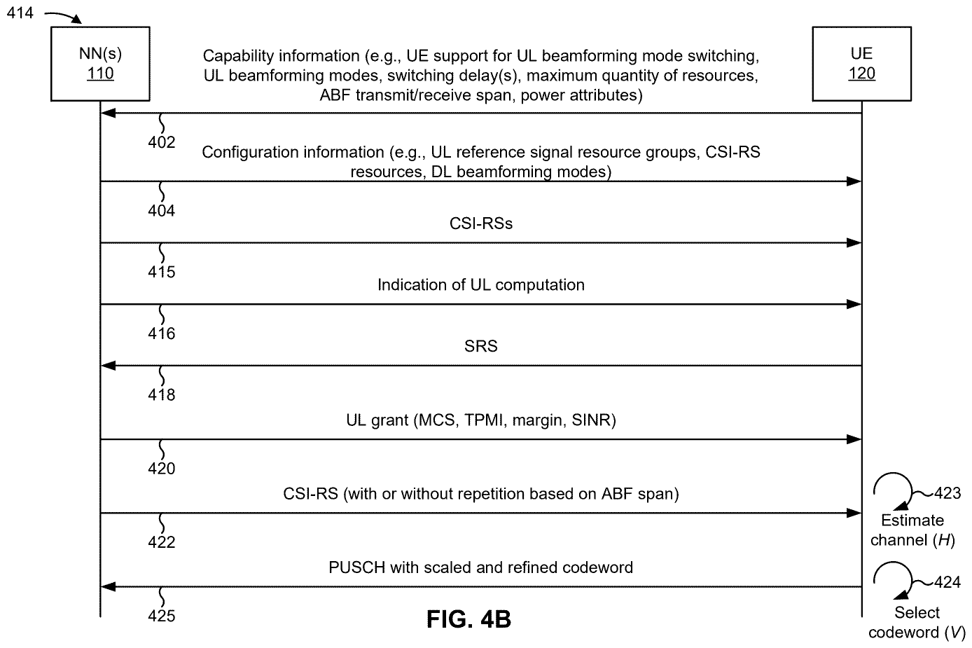

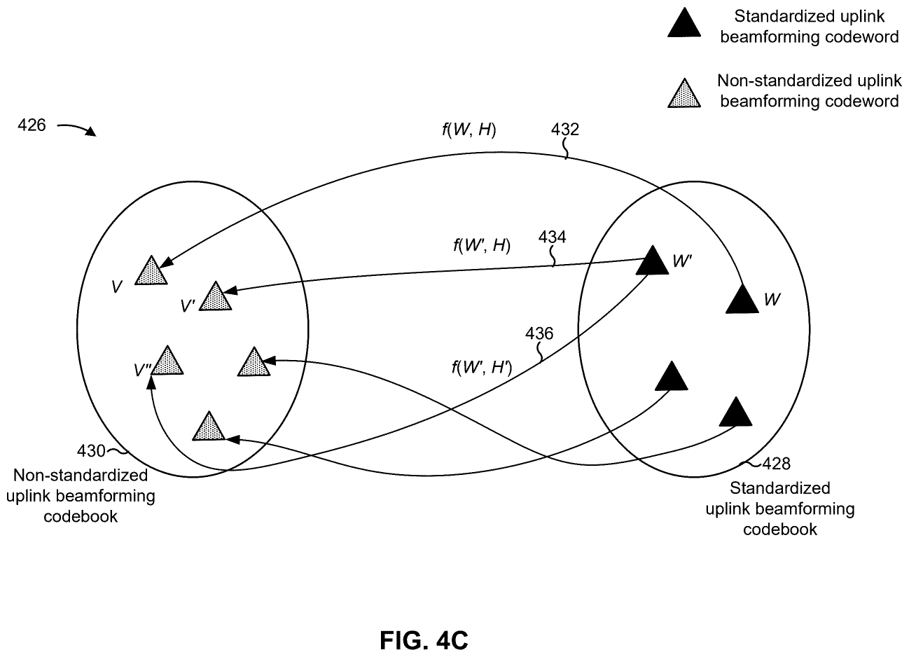

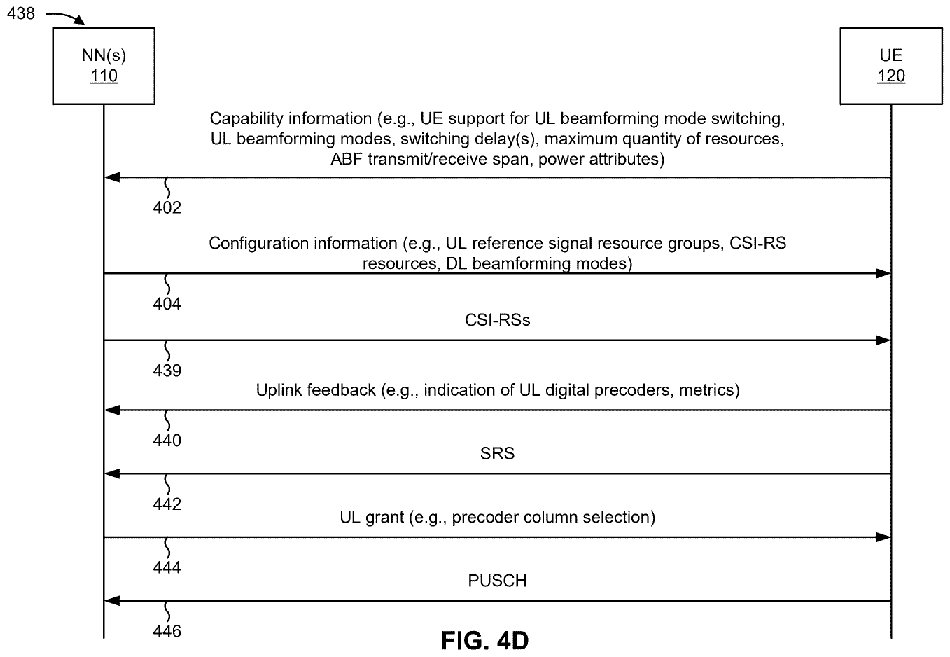

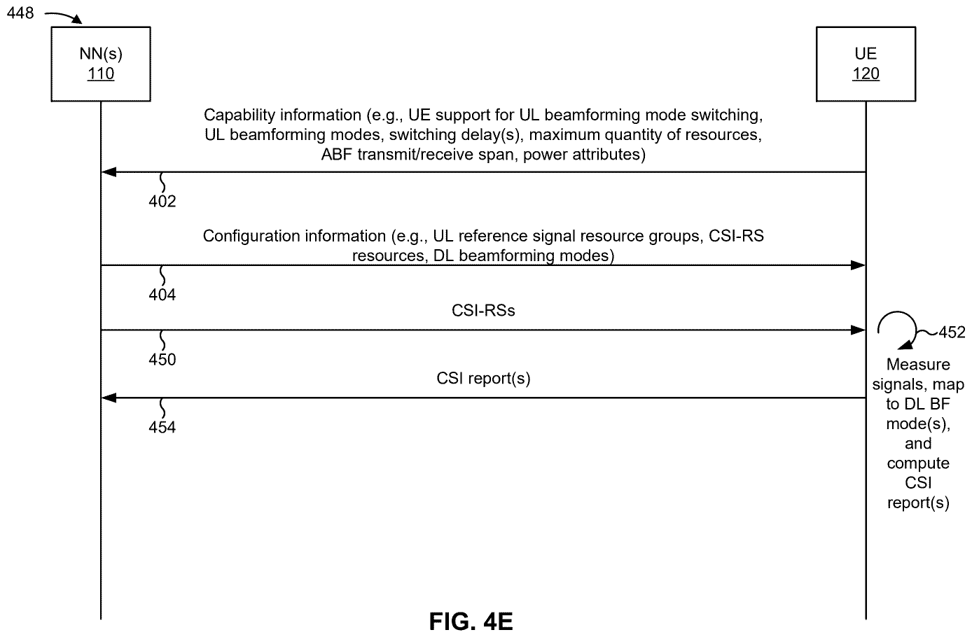

FIGS. 4A-4E are diagrams of examples associated with reference signal resources and signaling for beamforming mode switching. As shown in FIGS. 4A-4E, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIGS. 4A-4E. In some aspects, the network node 110 and the UE 120 may be capable of communicating using beamforming, such as by using a transmit/receive beamforming pair. Additionally, or alternatively, one or both of the network node 110 and the UE 120 may be capable of performing RF chain or antenna element adaptation to switch between beamforming modes, such as between one or more of the beamforming modes described above in connection with FIGS. 3A-3D, one or more analog beamforming modes, one or more digital beamforming modes, one or more hybrid beamforming modes, or any combination thereof.

As shown in FIG. 4A, and by example 400, the UE 120 may transmit, and the network node 110 may receive, capability information (as indicated by reference number 402). The capability information may be included in a capability report. The UE 120 may transmit the capability information via an uplink communication, a sidelink communication, a unicast communication, a broadcast communication, a UE assistance information (UAI) communication, an UCI communication, a sidelink control information (SCI) communication, a MAC-CE communication, an RRC communication, a PUCCH, a PUSCH, a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter for uplink beamforming mode switching. As another example, the capability information may indicate a capability or parameter for dynamic uplink beamforming mode adaptation, such as by activating/deactivating RF chains (e.g., TXRUs 362) or antenna elements (e.g., antenna elements 366). One or more operations described herein may be based on capability information. For example, the UE 120 may perform a communication in accordance with the capability information, or may receive configuration information that is in accordance with the capability information.

In some aspects, the capability information may indicate whether the UE 120 supports uplink beamforming mode switching, or whether the UE 120 supports measurements and signaling related to uplink beamforming mode switching (e.g., the measurements and signaling described below). In some aspects, the capability information may indicate a quantity/types of different uplink beamforming modes supported by the UE 120, minimum switching delays corresponding to the different uplink beamforming modes, maximum quantities of digital ports/resources for each uplink beamforming mode, or similar capability information. Additionally, or alternatively, the capability information may indicate one or more ABF spans, such as an ABF transmit span (e.g., a maximum number of antenna elements with independent analog phase or amplitude control that a transmit RF chain can be connected to at the UE 120) or an ABF receive span (e.g., a maximum number of antenna elements with independent analog phase or amplitude control that a receive RF chain can be connected to at the UE 120). In some aspects, the capability information may indicate power attributes associated with one or more uplink beamforming modes, such as total power associated with an uplink beamforming mode, maximum power per RF chain associated with an uplink beamforming mode, default pilot-to-data power offsets associated with an uplink beamforming mode, or similar power attributes associated with an uplink beamforming mode.

As shown by reference number 404, the network node 110 may transmit, and the UE 120 may receive, configuration information. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may include an indication of one or more uplink reference signal resource groups associated with an uplink beamforming mode switching capability of the UE 120. Put another way, based at least in part on the UE 120 reporting a dynamic uplink beamforming mode switching capability, one or more uplink reference signal resource groups may be configured for the UE 120. In some aspects, such as aspects in which the configuration information indicates multiple uplink reference signal resource groups, different groups may include different quantities of resources. In some aspects, such as in aspects in which the UE 120 is associated with a multi-TRP operation, multiple uplink reference signal resource groups may be configured for the UE 120.

In some aspects, resources within an uplink reference signal resource group may be associated with a same uplink beamforming mode or a same set of uplink beamforming parameters, such as a same quantity of antenna elements (e.g., antenna elements 366) per port (e.g., per RF chain or TXRU 362), a same transmit power (e.g., a same total transmit power or a same transmit power per port), a same quantity of ports and precoding mode (e.g., one of codebook-based or non-codebook-based, described in more detail below), or a same spatial relationship or unified TCI state, among other examples.

In some aspects, the one or more uplink reference signal resource groups may associated with one or more SRS resource sets. For example, in some aspects, each uplink reference signal resource group may be associated with a respective subset of resources of an SRS resource set. Put another way, a single SRS resource set may be configured for the UE 120 and divided into multiple groups/subsets of resources, with each of the groups/subsets of resources corresponding to an uplink reference signal resource group or uplink beamforming mode. In some other aspects, each uplink reference signal resource group, of the one or more uplink reference signal resource groups, may be associated with a respective SRS resource set. That is, an SRS resource set may correspond to an uplink reference signal resource group, and multiple SRS resource sets (e.g., one for each uplink beamforming mode) may comprise a super set (e.g., a set of all uplink reference signal resource groups configured for the UE 120).

Additionally, or alternatively, in some aspects, certain properties may be shared across all of the uplink reference signal resource groups in a set of uplink reference signal resource groups configured for the UE 120. For example, all uplink reference signal resource groups in a set of uplink reference signal resource groups may be associated with a same resource type, such as one of periodic, semi-persistent, or aperiodic. Additionally, or alternatively, all uplink reference signal resource groups in a set of uplink reference signal resource groups may be associated with a same set of downlink reference signals (e.g., CSI-RSs), such as for aspects involving non-codebook based beamforming (described in more detail below). Moreover, in some aspects, digital precoding may be applied (e.g., using a digital precoding component 370) within an uplink reference signal resource group. More particularly, for codebook-based beamforming, digital precoding may be applied across different ports of a selected resource within an uplink reference signal resource group. In some aspects, such as aspects involving non-codebook-based beamforming, SRS resources from different groups may not be simultaneously selected for transmission.

In some aspects, the configuration information may indicate one or more CSI-RS resources based at least in part on the capability information (e.g., based at least in part on an uplink beamforming mode switching capability of the UE 120). Additionally, or alternatively, the configuration information may indicate CSI-RS resources associated with a downlink beamforming mode switching capability of a network node. In such aspects, the configuration information may additionally indicate multiple downlink beamforming modes that are to be used by the network node 110 to transmit signals to the UE 120 associated with the CSI-RS resources, with each downlink beamforming mode being associated with a different subset of the CSI-RS resources. Aspects of the network node 110 configuring the UE 120 with CSI-RS resources associated with an uplink beamforming mode switching capability of the UE 120 or CSI-RS resources associated with a downlink beamforming mode switching capability of the network node 110 are described in more detail below in connection with FIGS. 4B-4E.

The UE 120 may configure itself based at least in part on the configuration information. In some aspects, the UE 120 may be configured to perform one or more operations described herein based at least in part on the configuration information.

As indicated by reference number 406, the UE 120 may transmit, and the network node 110 may receive, one or more uplink reference signals based at least in part on the configuration information (e.g., using resources associated with the configured uplink reference signal resource groups). In that regard, the UE 120 may transmit pilot signals to the network node using different uplink beamforming modes (e.g., by activating/deactivating RF chains (e.g., TXRUs 362), antenna elements (e.g., antenna elements 366), PAs, or similar parameters). For example, returning to the examples described above in connection with FIGS. 3C and 3D, the UE 120 may transmit a first set of signals associated with two wide beams (e.g., using two antenna elements per digital port and four digital ports per resource, among other examples), a second set of signals associated with four narrow beams (e.g., using four antenna elements per digital port and two digital ports per resource, among other examples), and so forth.

Moreover, as indicated by reference number 408, in some aspects the UE 120 may transmit, and the network node 110 may receive, an indication of a preferred uplink beamforming mode to be used by the UE 120. Put another way, the UE 120 may request/notify a preferred uplink beamforming mode to the network node 110, which, in some aspects, may be triggered by a detection of one or more events, such as high-power consumption at the UE 120 (e.g., detection that a power consumption at the UE 120 satisfies a threshold), a maximum permissible exposure (MPE) detection at the UE 120 (e.g., detection that an MPE level at the UE 120 satisfies a threshold), or similar events. In some aspects, one or more events that may trigger the UE 120 to transmit an indication of a preferred uplink beamforming mode may be specified in a relevant wireless communication standard (e.g., a standard promulgated by the 3GPP) or may be configured for the UE 120 by the network node 110 (e.g., via the configuration information described above in connection with reference number 404). In some aspects, the UE 120 may transmit the indication of the preferred uplink beamforming mode via a UCI communication, a MAC-CE communication, an RRC communication (e.g., using UAI), or a similar communication.

As indicated by reference number 410, the UE 120 may receive explicit or implicit feedback based at least in part on transmitting the one or more uplink reference signals (as described above in connection with reference number 406) or based at least in part on transmitting the indication of the preferred uplink beamforming mode (as described above in connection with reference number 408). For example, in some aspects, receiving the feedback may include receiving, from the network node 110, an indication of a selected uplink beamforming mode (e.g., an uplink beamforming mode to be used by the UE 120 to communicate with the network node 110). More particularly, the network node 110 may select an uplink beamforming mode (e.g., the network node 110 may select an uplink reference signal resource group index) based at least in part on measuring uplink reference signals across multiple uplink reference signal resource groups (e.g., multiple SRS groups or multiple subsets of a single SRS group, among other examples), and the network node 110 may indicate the selected uplink beamforming mode to the UE 120.

In some aspects, the network node 110 may indicate the selected uplink beamforming mode using an uplink scheduling DCI communication. Put another way, when scheduling the UE 120 to perform an uplink transmission via DCI, the network node 110 may indicate an uplink beamforming mode to be used for that uplink transmission. For example, in some aspects, the network node 110 may indicate the selected uplink beamforming mode using a resource group indication field of an uplink scheduling DCI communication. Put another way, a resource group indication field (sometimes referred to herein as a reference signal (RS) group indication field) may be defined or added to DCI, and the network node 110 may use the RS group indication field to indicate the uplink reference signal group index of the selected uplink beamforming mode. In some other aspects, an existing field of an uplink scheduling DCI communication may be repurposed to indicate the selected uplink beamforming mode. For example, in aspects in which each uplink reference signal resource group is associated with a respective SRS resource set, an SRS resource set indication field (e.g., an SRS resource indicator (SRI)) of the uplink scheduling DCI communication may be used to indicate the selected uplink beamforming mode (e.g., to indicate the SRS resource set index associated with the selected uplink beamforming mode).

Additionally, or alternatively, in aspects in which the network node 110 transmits the uplink scheduling DCI communication to the UE 120 (e.g., to indicate the selected uplink beamforming mode, or otherwise), certain DCI fields may be differently interpreted by the UE 120 based at least in part on the selected uplink beamforming mode (e.g., the indicated uplink reference signal resource group). For example, some fields of the uplink scheduling DCI communication, such as a transmitted precoding matrix indicator (TPMI) field or an SRI, among other examples, may be differently interpreted based at least in part on the indicated uplink reference signal resource group, because different uplink reference signal resource groups may be associated with a different quantity of resources, ports, or other parameters. Accordingly, for such fields, a respective field size may be determined by the maximum size across all uplink reference signal resource groups, and a portion of a field (e.g., the most significant bits (MSBs) or least significant bits (LSBs), among other examples) may be used by the UE 120 based at least in part on the indicated uplink reference signal resource group (e.g., the indicated uplink beamforming mode). Additionally, or alternatively, in aspects involving uplink multi-TRP operation, for such fields, a respective field size may be determined per TRP and based at least in part on the set of uplink reference signal resource groups associated with that TRP.

In some aspects, such as aspects in which the network node 110 transmits the uplink scheduling DCI communication to the UE 120 (e.g., to indicate the selected uplink beamforming mode, or otherwise), a scheduling offset indicated by the uplink scheduling DCI communication may be greater than or equal to a minimum uplink beamforming mode switching delay associated with the UE 120 (which, in some aspects, may be indicated via the capability information described above in connection with reference number 402), so that the UE 120 may successfully switch uplink beamforming modes (if necessary) prior to performing the scheduled uplink communication. Put another way, in some aspects, the uplink scheduling DCI communication may indicate a scheduling offset associated with an uplink communication that is scheduled by the DCI, and the scheduling offset may be greater than or equal to a minimum mode switching delay associated with the selected uplink beamforming mode indicated by the uplink scheduling DCI communication. In that regard, in some aspects, only entries in a time domain resource allocation (TDRA) table that may be used or signaled by the network node 110 may be TDRA table entries that are associated with a scheduling offset that is at least as long as the minimum mode switching delay associated with the selected uplink beamforming mode. Additionally, or alternatively, in some aspects, offsets in the TDRA table may be modified to accommodate for the minimum mode switching delay associated with the selected uplink beamforming mode, such as by adding an extra offset (e.g., adding the minimum mode switching delay) to the offsets in the TDRA table or by scaling up the entries in the TDRA table. In some other aspects, when the DCI indicates mode switching, a different TDRA table (e.g., a separately configured TDRA table, such as a beamforming-mode-switching-specific TDRA table) with larger scheduling offset values may be used, among other examples.

In some aspects, an indication of a selected uplink beamforming mode transmitted by the network node 110 to the UE 120 may be a sticky indication (e.g., may apply until an indication selecting a different uplink beamforming mode is received by the UE 120); in some other aspects, an indication of a selected uplink beamforming mode transmitted by the network node 110 to the UE 120 may be a one-time indication (e.g., may only apply to the uplink transmission scheduled by the uplink scheduling DCI communication). Put another way, in some aspects, the indication of the selected uplink beamforming mode may apply only to an uplink communication scheduled by the uplink scheduling DCI communication, while, in some other aspects, the indication of the selected uplink beamforming mode may apply to one or more uplink communications to be performed after reception of the uplink scheduling DCI communication and prior to reception of a subsequent uplink scheduling DCI communication indicating another selected uplink beamforming mode.

Moreover, although the indication of the selected uplink beamforming mode is described above in context of an uplink scheduling DCI communication, in some other aspects, the network node 110 may transmit the indication of the selected uplink beamforming mode using a different type of communication, such as a different type of DCI communication, a MAC-CE, an RRC message, or a similar communication. For example, in uplink control channel communications (e.g., PUCCH or UCI) or configured grant PUSCH (CG-PUSCH) communications, an uplink scheduling DCI communication may not be used to schedule an uplink transmission, and thus the network node 110 may indicate the selected uplink beamforming mode using a different communication (e.g., a different type of DCI communication, a MAC-CE, an RRC message, or the like).

In some other aspects, the feedback or indication of the selected uplink beamforming mode may be implicit. For example, in some aspects, the feedback may be based at least in part on the indication of the preferred uplink beamforming mode described above in connection with reference number 408, such as by being associated with a delay after transmitting the indication of the preferred uplink beamforming mode satisfying a threshold or reception of an acknowledgement message associated with the indication of the preferred uplink beamforming mode. Put another way, in some aspects, the UE 120 may transmit the indication of the preferred uplink beamforming mode, and then may autonomously apply the preferred uplink beamforming mode if a certain time period passes without receiving a contrary indication from the network node 110 or if the network node 110 acknowledges receipt of the indication of the preferred uplink beamforming mode indication (e.g., using a HARQ ACK indication) without signaling a contrary selected uplink beamforming mode.

As indicated by reference number 412, the UE 120 and the network node 110 may communicate using the selected uplink beamforming mode. More particularly, the UE 120 may switch to the selected uplink beamforming mode (e.g., the explicitly or implicitly indicated uplink beamforming mode described above in connection with reference number 410), such as by activating/deactivating RF chains (e.g., TXRUs 362), antenna elements (e.g., antenna elements 366), or similar components associated with the selected uplink beamforming mode, and the UE 120 may transmit uplink communications to the network node 110 using the selected uplink beamforming mode.

FIG. 4B shows an example 414 associated with CSI-RS-based uplink beamforming mode adaptation. Example 414 may be associated with the UE 120 performing uplink beamforming mode adaptation in connection with a codebook-based UL-MIMO communication. “Codebook” refers to a set of candidate codewords (sometimes referred to herein as beamforming matrices, precoding matrices, or precoders) to be used by a wireless communication device in MIMO communications. In codebook-based UL-MIMO communications, a UE may use a codeword (e.g., a precoder) that is selected from a standardized uplink codebook (e.g., a codebook defined by a wireless communication standard, such as a standard promulgated by the 3GPP). This standardized uplink codebook may have a limited size and thus may provide limited support for a flexible UE architecture, such as a UE architecture associated with activating/deactivating RF chains (e.g., TXRUs 362) or antenna elements (e.g., antenna elements 366) in order to switch between uplink beamforming modes, among other examples.

Accordingly, the aspects shown and described in connection with example 414 may enable use of an uplink codebook having a larger size than a standardized codebook, without a need for standardizing a larger codebook and thus increasing overhead associated with signaling a selected codeword from the codebook. Additionally, or alternatively, the aspects shown and described in connection with example 414 may enable support for a flexible UE architecture (such as by enabling per-active-chain analog beam training by the UE 120) without requiring precoded SRS transmissions by UE 120, among other examples.

More particularly, in a similar manner as described above in connection with FIG. 4A, the UE 120 may transmit, and the network node 110 may receive, the capability information (as described above in connection with reference number 402), and the network node 110 may transmit, and the UE 120 may receive, the configuration information based at least in part on the capability information (as described above in connection with reference number 404). In this aspect, the configuration information may indicate one or more CSI-RS resources that are associated with an uplink beamforming mode switching capability of the UE 120. For example, the CSI-RS resources may be associated with a CSI-RS resource set with a repetition set to “on” or with a repetition based at least in part on an ABF span associated with the UE 120 (e.g., an ABF span indicated by the capability information). Accordingly, as indicated by reference number 415, the network node 110 may transmit, and the UE 120 may receive and measure, CSI-RSs using the CSI-RS resources, and thus the UE 120 may determine a joint-analog/digital codeword based at least in part on the CSI-RSs.

In some aspects, the CSI-RS resources may be precoded by the network node 110 based at least in part upon the network node 110's estimated receive noise plus interference matrix (Rnn) or the diagonal elements of that matrix. Such precoding may allow the network node 110 to embed the effects of the noise plus interference suppression that the network node 110 will employ for data reception in the uplink onto the channels estimated by the UE 120 based on the precoded CSI-RS resources.

Moreover, as indicated by reference number 416, the network node 110 may transmit, and the UE 120 may receive, an indication that the UE 120 is to determine an uplink beamforming codeword (e.g., a customized or non-standardized uplink beamforming codeword, described in more detail below) for performing an uplink transmission, or that the configured CSI-RS resources are associated with determining the uplink beamforming codeword (e.g., the customized or non-standardized uplink beamforming codeword). More particularly, as described in more detail below in connection with reference number 424 and FIG. 4C, the UE 120 may be capable of mapping an indication of a standardized codeword (e.g., a TPMI) to a non-standardized codeword (e.g., a customized codeword) based at least in part on channel conditions (e.g., as determined from the measured CSI-RS resources), among other examples. Accordingly, in aspects in which the UE 120 indicates (e.g., via the capability information) that the UE 120 is capable of determining the non-standardized uplink beamforming codeword, the network node 110 may use the indication shown in connection with reference number 416 to alert the UE 120 that the UE 120 is to determine the non-standardized uplink beamforming codeword. Put another way, the network node 110 may indicate to the UE 120 that the UE 120 is to optimize an ABF or digital-port activation/deactivation for a subsequent uplink transmission (e.g., a subsequent UL-MIMO operation) based on transmit power, channel conditions, or other parameters.

In some aspects, the indication that the UE 120 is to determine the uplink beamforming codeword may be transmitted via the configuration information described above in connection with reference number 404 (e.g., via RRC signaling). For example, the indication that the UE 120 is to determine the uplink beamforming codeword may be associated with an IE in a CSI-RS resource set configuration that indicates that the CSI-RS resource set is to be used for determining a non-standardized uplink beamforming codeword. In some other aspects, the indication that the UE 120 is to determine the uplink beamforming codeword may be received via different signaling, such as via different RRC signaling, a MAC-CE, DCI, or similar signaling.

As indicated by reference number 418, the UE 120 may transmit, and the network node 110 may receive, one or more pilot signals (e.g., reference signals) using one or more uplink reference signal resources, such as resources associated with an uplink reference signal resource group (in a similar manner as described above in connection with reference number 406), resources associated with an SRS resource set, or similar resources. In some aspects, transmitting the one or more pilot signals using the one or more uplink resources may include the UE 120 performing uplink sounding using multiple virtual ports, with each virtual port created using a local ABF for each RF chain, performing uplink sounding using digital ports without digital precoding, or performing similar sounding procedures. In some aspects, the configuration information described above in connection with reference number 404 may thus include an uplink reference signal configuration (e.g., an SRS resource set configuration, among other examples) that enables dynamic port selection and SRS sounding by the UE 120. Additionally, or alternatively, in some aspects the UE 120 may be enabled to choose a quantity of digital ports to activate in order to transmit the uplink reference signals, among other examples.

As indicated by reference number 420, the network node 110 may transmit, and the UE 120 may receive, an uplink grant (e.g., an uplink scheduling DCI) indicating certain parameters to be used for an uplink transmission (e.g., an UL-MIMO operation) or selection of an uplink beamforming codeword to be used for the uplink transmission. For example, the uplink grant may indicate an MCS associated with the uplink transmission or a TPMI associated with the uplink transmission (e.g., an index pointing to a specific precoding matrix from a standardized codebook associated with the uplink transmission). In such aspects, the uplink beamforming codeword associated with the TPMI may serve as a starting point for the UE 120 to select a non-standardized uplink beamforming codeword for the uplink transmission, as described in more detail below in connection with reference number 424 and FIG. 4C.

Moreover, the uplink grant or similar transmission may further indicate one or more parameters associated with the UE 120 determining the non-standardized uplink beamforming codeword, such as a margin associated with the non-standardized uplink beamforming codeword (sometimes referred to herein as ε), or an SINR associated with the non-standardized uplink beamforming codeword (sometimes referred to herein as an SINR threshold, a cutoff SINR, or γ). “Margin” (e.g., ε) refers to a subspace distance between a column-subspace of a vector HV (where H corresponds to an estimated channel and V corresponds to a non-standardized uplink beamforming codeword) and a vector HW (where W corresponds to a standardized uplink beamforming codeword, such as a codeword associated with a TPMI signaled in the uplink grant), which is described in more detail below in connection with FIG. 4C. “Cutoff SINR” (e.g., γ) refers to a minimum SINR that is to be achieved using the non-standardized uplink beamforming codeword.

As indicated by reference number 422, the network node 110 may transmit, and the UE 120 may receive, signals using the one or more CSI-RS resources. In some aspects, the signals may be transmitted using a repetition based at least in part on an ABF associated with the UE 120, while, in some other aspects, the signals may be transmitted without repetition. In some aspects, as indicated by reference number 423, the UE 120 may process the signals (e.g., the CSI-RSs), such as by estimating a channel (e.g., H) based at least in part on the signals. Put another way, the UE 120 may determine an estimated channel based at least in part on the one or more channel CSI-RS resources (e.g., the CSI-RS resources configured via the configuration information described above in connection with reference number 404). In some aspects, the UE 120 may process the CSI-RSs (e.g., estimate the channel) using only CSI-RSs that are associated RBs assigned in the uplink grant described above in connection with reference number 420.

As indicated by reference number 424, the UE 120 may select a codeword (e.g., a non-standardized codeword) based at least in part on measuring the signals associated with the one or more CSI-RS resources or estimating the channel associated with the one or more CSI-RS resources. For example, in some aspects the UE 120 may determine the uplink beamforming codeword by mapping an indication of a standardized uplink beamforming codeword (e.g., TPMI or W, which may be indicated to the UE 120 using the uplink grant, as described above) to the non-standardized uplink beamforming codeword (e.g., V) based at least in part on the estimated channel (e.g., H). Moreover, in some aspects, the UE 120 may further map the standardized uplink codeword to the selected uplink beamforming codeword based at least in part on the margin (e.g., ε) or the SINR cutoff (e.g., γ), among other examples (as described in more detail below in connection with FIG. 4C). Put another way, in the operations indicated by reference number 424, the UE 120 may perform uplink beamforming codeword refinement (e.g., refinement of a standardized uplink beamforming codeword) based at least in part on TPMI, a channel estimated from CSI-RSs, or other parameters (e.g., the margin or SINR cutoff), which may result in selection of an optimized uplink beamforming codeword and thus reduction in transmit power (optionally while achieving a certain SINR at-least as large as the cutoff SINR γ and satisfying margin ε), or an improved/refined uplink beamforming codeword (e.g., a codeword resulting in an even higher SINR and satisfying margin ε) using a same transmit power as would be needed using the standardized uplink beamforming codeword indicated by the TPMI.

As indicated by reference number 425, the UE 120 and the network node 110 may communicate using the selected uplink beamforming codeword (e.g., the refined or non-standardized codeword described above). For example, the UE 120 may perform an UL-MIMO operation using the non-standardized codeword, such as by transmitting a PUSCH communication to the network node 110 using beamforming based at least in part on scaled or refined uplink beamforming codeword, as described above.

FIG. 4C shows an example 426 associated with mapping a standardized uplink beamforming codeword (e.g., W) to a non-standardized uplink beamforming codeword (e.g., V), or mapping a standardized uplink beamforming codebook 428 to a non-standardized uplink beamforming codebook 430. In some aspects, a non-standardized uplink beamforming codeword may be determined based at least in part on a function of a standardized uplink beamforming codeword (e.g., W, which may be indicated to the UE 120 via a TPMI in an uplink grant, among other examples) and an estimated channel (e.g., H). More particularly, the function (denoted in FIG. 4C as ƒ(W,H)), sometimes referred to herein as a mapping rule, may be defined in such a way that each TPMI or codeword (e.g., beamforming vector/matrix), W, in a standardized uplink beamforming codebook 428 identifies at least one other codeword, V, not necessarily in that standardized codebook (e.g., in the non-standardized uplink beamforming codebook 430). In such aspects, the function (e.g., mapping rule) may take as input at least the TPMI (e.g., indicating the standardized uplink beamforming codeword, W) and channel estimate (e.g., H), and optionally take as input a cutoff SINR (e.g., γ) or a margin (e.g., ε), and may output the non-standardized uplink beamforming codeword, V.

Put another way, the mapping rule may be expressed as ƒ(W,H)=V, such that a subspace distance between column-subspace of HV and HW is no greater than a margin ε (e.g., d(HV,HW)≤ε), with H corresponding to the uplink channel estimate obtained by the UE 120 using CSI-RSs (e.g., as described above in connection with reference numbers 422 and 423), and with d(.,.) corresponding to a normalized subspace distance (e.g., Chordal, cosine-similarity, or p-metric, among other examples). For example, as shown in FIG. 4C, and as indicated by reference number 432, a first TPMI or standardized uplink beamforming codeword (shown as W) may map to a first non-standardized uplink beamforming codeword (shown as V) for a first estimated channel (shown as H). Similarly, as indicated by reference number 434, a different TPMI or standardized uplink beamforming codeword (shown as W′) may map to a different non-standardized uplink beamforming codeword (shown as V′) for the same estimated channel (e.g., H). Moreover, the TPMIs or standardized uplink beamforming codewords may map to different non-standardized uplink beamforming codewords under different channel conditions, as indicated by reference number 436 (e.g., the standardized uplink beamforming codeword W′ may map to a different non-standardized uplink beamforming codeword (shown as V″) than the one indicated by reference number 434 when channel conditions change (as indicated using H′)).

In such aspects, because a subspace of HW may be received at the network node 110 with reduced interference (e.g., assuming H remains relatively similar across a corresponding SRS and CSI-RS), it may be desirable for a subspace of HV to not deviate too much from the subspace of HW. Thus, the network node 110 may configure the margin (e.g., ε) semi-statically (e.g., via the configuration information described above in connection with reference number 404) or dynamically (e.g., via the uplink grant described above in connection with reference number 420 or a similar dynamic indication). Additionally, or alternatively, in aspects in which the network node 110 configures or otherwise signals a cutoff SINR (e.g., γ), the UE 120 may select an uplink beamforming codeword such that an estimated SINR achieved with V given H may be greater than or equal to the indicated cutoff SINR. In such aspects, the non-standardized uplink beamforming codeword (e.g., V) may be realized by the UE 120 in a more power-efficient manner than the standardized uplink beamforming codeword (e.g., W), or else the non-standardized uplink beamforming codeword (e.g., V) may achieve a better beamforming gain than the standardized uplink beamforming codeword (e.g., W) for a given transmit power.

FIG. 4D shows another example 438 associated with CSI-RS-based uplink beamforming mode adaptation. Example 438 may be associated with the UE 120 performing uplink beamforming mode adaptation in connection with a codebook-based UL-MIMO communication. Non-codebook-based UL-MIMO communications may require a precoded SRS transmission by a UE, may be associated with certain restrictions regarding SRS transmission periodicity, or may provide limited support for a flexible UE architecture. In the codebook-based UL-MIMO aspects shown and described in connection with example 438, however, there may be no need for a precoded SRS transmission by the UE 120, and the example 438 may enable flexible network node 110 or UE 120 operation (such as by enabling per-active-chain analog beam training by the network node 110 and the UE 120, among other examples).

As described above in connection with FIG. 4A, the UE 120 may transmit, and the network node 110 may receive, the capability information (as described above in connection with reference number 402), and the network node 110 may transmit, and the UE 120 may receive, the configuration information based at least in part on the capability information (as described above in connection with reference number 404). In some aspects, the configuration information may indicate a CSI-RS resource configuration that includes M different CSI-RS resource sets, each with repetition set to “on” (e.g., based on ABF span reported in capability information). In such aspects, and as indicated by reference number 439, the network node 110 may transmit signals (e.g., CSI-RSs) based at least in part on the CSI-RS resource configuration (e.g., using the M CSI-RS resource sets). In some aspects, the network node 110 may transmit, for the i^{th} CSI-RS resource set, all CSI-RSs using Tᵢ network node 110 ports, with the values of Tᵢ conveyed to UE 120 (e.g., via the configuration information described above in connection with reference number 404). Furthermore, a different UE transmit power limit may be indicated for each CSI-RS resource set in the configuration information that the UE 120 is to use in the UE 120's metric computation and precoder selection. Additionally, or alternatively, a set of sub-bands may be indicated for each CSI-RS resource set in the configuration information. In such aspects, the set of sub-bands may be the set of sub-bands for which the UE 120 assumes the UE 120's available transmit power (e.g., up to any indicated corresponding limit) will be divided over for the UE 120's metric computation detailed below. Moreover, since the UE 120 is informed that the computations are to be made for the uplink, the UE 120 may must reinterpret the power offset field in each CSI-RS resource set configuration information and apply the power offset as a ratio of CSI-RS resource element power to PUSCH resource element power instead as the ratio of CSI-RS resource element power to PDSCH resource element power. Put another way, in some aspects, the configuration information may indicate multiple (e.g., M) CSI-RS resource sets, with each CSI-RS resource set, of the multiple CSI-RS resource sets, being associated with a different quantity of network node 110 transmit ports and possibly a different indicated set of sub-bands or UE transmit power limit.

As indicated by reference number 440, the UE 120 may transmit, based at least in part on measuring the signals associated with the one or more CSI-RS resource sets, uplink feedback that indicates at least one uplink beamforming codeword and a corresponding CSI-RS resource set associated with the uplink beamforming codeword. For example, in some aspects the UE 120 may report an uplink precoder (e.g., an uplink beamforming codeword) for each CSI-RS resource set along with an uplink metric for that uplink beamforming codeword, which may be a metric that is proportional to the UE 120's estimate of an expected uplink spectral efficiency for that uplink beamforming codeword (e.g., determined by incorporating the UE 120's power availability, indicated transmit power limit or set of sub-bands, or other constraints, such as MPE or similar constraints). In some other aspects, the uplink feedback may indicate an uplink beamforming codeword for less than all of the CSI-RS resources. For example, the UE may report an index (e.g., a CRI or similar index) identifying one CSI-RS resource set, an associated uplink precoder, or an associated uplink metric.

In some aspects, the uplink feedback may indicate the selected uplink beamforming codeword by indicating an index associated with an uplink beamforming codebook. For example, the UE 120 may be configured, preconfigured, hard-coded, or otherwise associated with an uplink beamforming codebook that is associated with multiple uplink beamforming sub-codebooks, with each uplink beamforming sub-codebook corresponding to a different quantity of UE transmit ports, and with each uplink beamforming sub-codebook being associated with multiple candidate uplink beamforming codewords. Put another way, the UE 120 may be configured, preconfigured, hard-coded, or otherwise associated with a composite uplink codebook (sometimes referred to herein as C), which may include a concatenation of sub-codebooks (sometimes referred to herein as C₁ through C_{L}, and thus C={C₁,C₂, . . . ,C_{L}}) corresponding to different quantities of UE transmit ports. In such aspects, the first set of codewords (e.g., C₁) may correspond to the UE 120 using a single transmit port, the next set of codewords (e.g., C₂) may correspond to the UE 120 using two transmit ports, and so forth.

Upon receipt of the uplink feedback (e.g., the index of the composite uplink codebook), the network node 110 may be able to deduce a quantity of ports that the network node 110 needs in order to schedule subsequent UE 120 uplink reference signal (e.g., SRS) sounding on. Accordingly, as indicated by reference number 442, the UE 120 may transmit, and the network node 110 may receive, one or more pilot signals (e.g., reference signals) using one or more uplink reference signal resources, such as resources associated with an uplink reference signal resource group (in a similar manner as described above in connection with reference number 406), resources associated with an SRS resource set, or similar resources. In some aspects, transmitting the one or more pilot signals using the one or more uplink resources may include the UE 120 performing sounding using digital ports without digital precoding, or similar sounding procedures. As indicated by reference number 444, the network node 110 may transmit, and the UE 120 may receive, an uplink grant (e.g., an uplink scheduling DCI), which may be similar to the uplink grant described above in connection with reference number 420 or which may indicate an uplink beamforming precoder column selection, among other information. Moreover, as indicated by reference number 446, the UE 120 may transmit, and the network node 110 may receive, an uplink transmission (e.g., a PUSCH) using the selected uplink beamforming precoder, and thus which may be substantially similar to the communication described above in connection with reference number 422.

In some other aspects, in order to reduce overhead associated with example 438 (e.g., to signaling overhead associated with the configuring the CSI-RS resource sets or signaling the various uplink beamforming codewords selected from the composite codebook, C), among other examples, a different type of CSI-RS resource configuration may be used by the network node 110 and the UE 120 to select an uplink beamforming codeword. For example, in some aspects the CSI-RS configuration may be associated with a single CSI-RS resource set optionally with repetition set to “on” that is based at least in part on an ABF span reported in the capability information. In such aspects, the single CSI-RS resource set may be associated with a quantity of network node transmit ports (sometimes referred to herein as T), and the UE 120 may measure the signals (e.g., CSI-RSs) associated with the one or more CSI-RS resources. In a computational instance, the UE may use at least a part of the UE 120's measurements of the transmitted CSI-RS resources, corresponding to a different quantity of ports that is less than or equal to the quantity of transmit ports (e.g., T). For example, a measurement of a port may be reused across computations of reports corresponding to different subsets in which that port occurs, such as a for a purpose of reducing measurement complexity or resource consumption because not all ports of each subset need to be measured afresh when subsets have overlaps or common measurements.

More particularly, in some aspects the network node 110 may transmit all CSI-RSs of the configured CSI-RS resource set using T network node 110 transmit ports, with the value of T being conveyed to the UE 120 (e.g., via the configuration information described above in connection with reference number 404). Moreover, in some aspects the CSI-RS configuration may be associated with a parameter, sometimes referred to herein as a subset indication or an emulation flag, that is set to a specific value, such as S (e.g., the CSI-RS resource set configuration may specify that an emulation flag IE is indicated with a quantity S). In such aspects, the UE 120 may select a pre-configured choice of a size-S subset of the T transmit ports to measure, and the UE 120 may report (e.g., via the uplink feedback described above in connection with reference number 440) an uplink beamforming codeword (e.g., an uplink precoder) and, optionally, an associated uplink metric (e.g., a metric proportional to the UE 120's estimate of expected uplink spatial efficiency, incorporating the UE 120's power availability and other constraints such as MPE).

In some other aspects, the UE 120 may select a pre-configured choice of size-L subset of the T transmit ports, where S≤L≤T. In such aspects, the UE 120 may report (e.g., via the uplink feedback described above in connection with reference number 440) for each L, an uplink beamforming codeword (e.g., an uplink precoder) and, optionally, the associated uplink metric. In some other aspects, the UE 120 may report (e.g., via the uplink feedback described above in connection with reference number 440) an index identifying one subset and an associated uplink beamforming codeword (e.g., an uplink precoder) and, optionally, the associated uplink metric.

For each pre-configured subset in the above cases, a set of sub-bands and/or a transmit power limit may also be indicated (or pre-configured), in which case the UE 120 may further incorporate the sub-bands or transmit power in the UE 120's corresponding metric computation and uplink precoder selection.

FIG. 4E shows an example 448 associated with CSI-RS-based downlink beamforming mode adaptation. In the downlink, traditional CSI-RS resources or traditional CSI-RS procedures may be used to obtain CSI for a candidate downlink beamforming mode or a preferred downlink beamforming mode. For example, different CSI-RS resources or CSI-RS resource sets may be associated with different downlink beamforming modes, and the UE 120 may select a resource (e.g., a CRI) and report the resource to the network node 110 along with other CSI and metrics (e.g., RI, PMI, CQI, and similar metrics). Additionally, or alternatively, certain channel state feedback (CSF) frameworks may enable adaptation of spatial domain elements or PDSCH/CSI-RS power offsets. More particularly, a CSI report may be configured that has L CSI report sub-configurations (with L>1), with each CSI report sub-configuration being associated with a different hypothesis for the spatial domain and/or power domain. In such examples, the UE 120 may report CSI associated with N CSI report sub-configurations in one CSI report, with N being a parameter indicated to the UE 120 by the network node 110.

Some aspects described herein may further enhance one or more of the above CSI-RS configurations and reporting mechanisms, such as by enabling one or more configurations or signaling mechanisms that reduce signaling overhead while enabling more flexible downlink beamforming mode adaptation procedures. For example, certain configurations and signaling mechanisms may enable selection of a subset of activated transmit RF-chains/ports, connected antenna elements per activated chain, and default power-offsets. Moreover, for computing CSI for an indicated downlink beamforming mode based on a configured associated CSI-RS resource, a mapping rule for mapping between chains activated under that mode and CSI-RS ports may be provided to UE 120, optionally along with additional power-offset values, among other examples.

More particularly, as described above in connection with FIG. 4A, the UE 120 may transmit, and the network node 110 may receive, the capability information (as described above in connection with reference number 402), and the network node 110 may transmit, and the UE 120 may receive, the configuration information based at least in part on the capability information (as described above in connection with reference number 404). In example 448, the configuration information may indicate CSI-RS resources associated with a downlink beamforming mode switching capability of a network node 110. Moreover, the configuration information may indicate multiple downlink beamforming modes, with each downlink beamforming mode being associated with a different subset of the CSI-RS resources.

More particularly, in some aspects the UE 120 may be configured to compute and report downlink CSI and metrics simultaneously for more than one downlink beamforming mode based at least in part on a common CSI-RS resource set. In such aspects, the various downlink beamforming modes may be configured and indicated to the UE 120 by network node 110 (e.g., via the configuration information described above in connection with reference number 404). In some aspects, a pre-configured selection of CSI-RS ports for each indicated downlink beamforming mode may be defined via a mapping (e.g., a mapping rule defined by a relevant wireless communication standard, such as a wireless communication standard promulgated by the 3GPP). For example, one downlink beamforming mode may be associated with a reference downlink beamforming mode, which may be associated with a quantity (e.g., L) of activated chains that are mapped to all L ports of a configured CSI-RS resource set. In some aspects, the mapping may be implicit, such as by mapping a first RS port to a chain with a lowest index, a second RS port to a chain with a second lowest index, and so forth.

Moreover, the mapping rule may associate a first set of one or more of the other downlink beamforming modes with subsets of the L CSI-RS ports having a first quantity of ports each (with the first quantity being equal to L−1 in some aspects), a second set of one or more other downlink beamforming modes with subsets of the L CSI-RS ports having a second quantity of ports each (with the second quantity being equal to L−2 in some aspects), and so forth. More generally, in some aspects a mapping rule may associate each of the indicated non-reference downlink beamforming modes with any pre-defined subset of CSI-RS ports of any cardinality of 1 through L−1 (with the subset being conveyed to UE 120, such as via RRC, MAC-CE, DCI, or a combination thereof, among other examples).

Additionally, or alternatively, based at least in part on the configuration information or otherwise, the UE 120 may obtain the CSI-RS power offset (e.g., scaling) values that the UE 120 should apply with each downlink beamforming mode in determining certain metrics for one or more CSI reports, such as SINR metrics, CQI metrics, or similar metrics. For example, the UE 120 may determine a CSI-RS power offset for a given downlink beamforming mode based at least in part on a default value in that downlink beamforming mode's definition, among other examples. Additionally, or alternatively, additional non-default offset values (or a set of offset values, one for each of the downlink beamforming mode's activated ports) may be indicated to the UE 120 (e.g., via RRC, MAC-CE, DCI, or a combination thereof, among other examples). Indicating non-default offset values to the UE 120 may enable obtaining CSI under different transmit ports and transmit power values, or may accommodate non-identical RF chains, thereby capturing specific beamforming hardware implementations at the network node 110.

As indicated by reference number 450, the network node 110 may transmit, and the UE 120 may receive, one or more CSI-RSs based at least in part on the configuration information described above. In that regard, the network node 110 may transmit the CSI-RSs using various downlink beamforming modes, such as the various downlink beamforming modes indicated to the UE 120 via the configuration information or mapped to subsets of the CSI-RS resources using one of the mapping rules described above, among other examples.

As indicated by reference number 452, the UE may measure the signals (e.g., the CSI-RSs) and may map signals and associated measurement results to the various downlink beamforming modes. For example, the UE may map the measurement results or a corresponding downlink beamforming mode to a respective subset of the CSI-RS resources. Moreover, the UE 120 may generate one or more CSI reports for reporting the downlink beamforming mode CSI to the network node 110. In some aspects, the one or more CSI reports may be based at least in part on applying a different CSI-RS power offset for each downlink beamforming mode, in a similar manner as described above.

As indicated by reference number 454, in some aspects the UE 120 may transmit, and the network node 110 may receive, one or more CSI reports based at least in part on the measurement of the signals associated with the CSI-RS resources. In some aspects, the one or more CSI reports may include a reference CSI report associated with the reference downlink beamforming mode and, for each downlink beamforming mode other than the reference downlink beamforming mode, a corresponding delta CSI report that is based at least in part on the reference CSI report. Put another way, one or more of the CSI reports may be provided as a differential (e.g., delta) report with respect to a reference downlink beamforming mode report. For example, ranks, PMIs, or similar parameters of a reference downlink beamforming mode and another downlink beamforming mode may be the same (e.g., identical PMI codebook subset restrictions may be indicated for both downlink beamforming modes). In such aspects, a full CSI report may be reported for the reference downlink beamforming mode and a differential CSI report may be reported for the other downlink beamforming mode. For example, in the delta report, a difference between absolute CQIs (e.g., SINRs) computed for the reference downlink beamforming mode and the other downlink beamforming mode may be quantized and reported by the UE 120.

In such aspects, a range of the differences between absolute CQIs (e.g., SINRs) computed for the reference downlink beamforming mode and the other downlink beamforming mode may be limited so that quantization to a desired accuracy can be achieved using a fewer number of bits than required for a full CSI report. Otherwise, a higher accuracy may be achieved using more bits. Additionally, or alternatively, in some aspects a common reference downlink beamforming mode may be specified for all other indicated downlink beamforming modes (e.g., all downlink beamforming modes indicated by the configuration information), while, in some other aspects, multiple downlink beamforming reference modes may be indicated. In aspects in which more than one reference downlink beamforming mode is used, the reference downlink beamforming modes may be specified in such a way as to avoid two downlink beamforming modes being references for each other. In that regard, the network node 110 or the UE 120 may, in some aspects, ensure that each reference downlink beamforming mode has no other downlink beamforming mode marked as a reference for that reference downlink beamforming mode, and that full, non-differential CSI is reported for that reference downlink beamforming mode. Additionally, or alternatively, two or more CSI reports may be obtained at different resolutions, among other examples.

Moreover, in some aspects, the one or more CSI reports may be based at least in part on one or more scheduling delay parameters associated with the multiple downlink beamforming modes. More particularly, the configuration information may indicate a corresponding offset (sometimes referred to herein as Δ) for one or more downlink beamforming modes, which may be indicated in terms of symbols, slots, absolute time, or a similar time period. In such aspects, the offset (e.g., Δ) may be used to indicate to the UE 120 that the UE 120 may be scheduled under the corresponding downlink beamforming mode (e.g., transmission hypothesis), if at all, no earlier than the offset time period (e.g., Δ symbols, slots, absolute time, or the like) after the associated CSI-RS resource. In such aspects, the UE 120 may determine the corresponding CSI reports by incorporating the delay information (e.g., via the UE 120's prediction mechanism). In some aspects, a common scheduling delay parameter or offset (e.g., a common Δ), rather than mode-specific scheduling delay parameters or offsets (e.g., mode-specific Δs), may be configured for all indicated downlink beamforming modes.

Additionally, or alternatively, the one or more CSI reports may indicate one or more preferred downlink beamforming modes (e.g., one or more downlink beamforming modes preferred by the UE 120). For example, the UE 120 may report an identifier (e.g., a mode index) identifying a preferred downlink beamforming mode (and, optionally, an associated CSI-RS resource subset) from the indicated downlink beamforming modes, along with corresponding downlink CSI and metrics for that preferred downlink beamforming mode. In some other aspects, the UE 120 may report multiple preferred downlink beamforming modes, such as by indicating a top k preferred modes/CSI-RS resource subsets, with k being a pre-defined parameter or signaled to the UE 120 (e.g., via the configuration information described above in connection with reference number 404).

Based at least in part on the UE 120 and the network node 110 implementing the reference signal resources and signaling for beamforming mode switching described above, the UE 120 or the network node 110 may conserve computing, power, network, or communication resources that may have otherwise been consumed during beamformed communications. For example, based at least in part on the UE 120 and the network node 110 implementing the reference signal resources and signaling for beamforming mode switching described above, the UE 120 and the network node 110 may operate using optimized beamforming codewords and thus may communicate with reduced power or with a reduced error rate, which may conserve computing, power, network, or communication resources that may have otherwise been consumed to detect or correct communication errors.

As indicated above, FIGS. 4A-4E are provided as examples. Other examples may differ from what is described with respect to FIGS. 4A-4E.

FIG. 5 is a diagram illustrating an example process 500 performed, for example, at a UE or an apparatus of a UE. Example process 500 is an example where the apparatus or the UE (e.g., UE 120) performs operations associated with reference signal resources and signaling for beamforming mode switching.

As shown in FIG. 5, in some aspects, process 500 may include receiving configuration information indicating one or more uplink reference signal resource groups associated with an uplink beamforming mode switching capability of the UE (block 510). For example, the UE (e.g., using reception component 802 or communication manager 806, depicted in FIG. 8) may receive configuration information indicating one or more uplink reference signal resource groups associated with an uplink beamforming mode switching capability of the UE, as described above.

As further shown in FIG. 5, in some aspects, process 500 may include transmitting one or more uplink reference signals based at least in part on the configuration information (block 520). For example, the UE (e.g., using transmission component 804 or communication manager 806, depicted in FIG. 8) may transmit one or more uplink reference signals based at least in part on the configuration information, as described above.

As further shown in FIG. 5, in some aspects, process 500 may include receiving feedback based at least in part on transmitting the one or more uplink reference signals (block 530). For example, the UE (e.g., using reception component 802 or communication manager 806, depicted in FIG. 8) may receive feedback based at least in part on transmitting the one or more uplink reference signals, as described above.

As further shown in FIG. 5, in some aspects, process 500 may include communicating using a selected uplink beamforming mode that is based at least in part on the feedback (block 540). For example, the UE (e.g., using reception component 802, transmission component 804, or communication manager 806, depicted in FIG. 8) may communicate using a selected uplink beamforming mode that is based at least in part on the feedback, as described above.

Process 500 may include additional aspects, such as any single aspect or any combination of aspects described below or in connection with one or more other processes described elsewhere herein.

In a first aspect, each uplink reference signal resource group, of the one or more uplink reference signal resource groups, is associated with one of a respective subset of resources of a SRS resource set, or a respective SRS resource set.

In a second aspect, alone or in combination with the first aspect, receiving the feedback includes receiving an indication of the selected uplink beamforming mode.

In a third aspect, alone or in combination with one or more of the first and second aspects, the indication of the selected uplink beamforming mode is associated with one of a resource group indication field of an uplink scheduling DCI communication, or a sounding reference signal resource indication field of the uplink scheduling DCI communication.

In a fourth aspect, alone or in combination with one or more of the first through third aspects, the uplink scheduling DCI communication indicates a scheduling offset associated with an uplink communication, and the scheduling offset is greater than or equal to a minimum mode switching delay associated with the selected uplink beamforming mode.

In a fifth aspect, alone or in combination with one or more of the first through fourth aspects, process 500 includes transmitting an indication of a preferred uplink beamforming mode, wherein receiving the feedback is further based at least in part on the indication of the preferred uplink beamforming mode.

In a sixth aspect, alone or in combination with one or more of the first through fifth aspects, the feedback is associated with at least one of a delay after transmitting the indication of the preferred uplink beamforming mode satisfying a threshold, or reception of an acknowledgement message associated with the indication of the preferred uplink beamforming mode.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a UE or an apparatus of a UE. Example process 600 is an example where the apparatus or the UE (e.g., UE 120) performs operations associated with reference signal resources and signaling for beamforming mode switching.

As shown in FIG. 6, in some aspects, process 600 may include transmitting capability information indicating an uplink beamforming mode switching capability of the UE (block 610). For example, the UE (e.g., using transmission component 804 or communication manager 806, depicted in FIG. 8) may transmit capability information indicating an uplink beamforming mode switching capability of the UE, as described above.

As further shown in FIG. 6, in some aspects, process 600 may include receiving configuration information from a network node indicating one or more CSI-RS resources based at least in part on the capability information (block 620). For example, the UE (e.g., using reception component 802 or communication manager 806, depicted in FIG. 8) may receive configuration information from a network node indicating one or more CSI-RS resources based at least in part on the capability information, as described above.

As further shown in FIG. 6, in some aspects, process 600 may include communicating using a selected uplink beamforming codeword that is based at least in part on measuring signals associated with the one or more CSI-RS resources (block 630). For example, the UE (e.g., using reception component 802, transmission component 804, or communication manager 806, depicted in FIG. 8) may communicate using a selected uplink beamforming codeword that is based at least in part on measuring signals associated with the one or more CSI-RS resources, as described above.

Process 600 may include additional aspects, such as any single aspect or any combination of aspects described below or in connection with one or more other processes described elsewhere herein.

In a first aspect, process 600 includes receiving an indication that the UE is to determine the selected uplink beamforming codeword, determining an estimated channel based at least in part on the one or more CSI-RS resources, and determining the selected uplink beamforming codeword by mapping a received indication of a standardized uplink beamforming codeword to the selected uplink beamforming codeword based at least in part on the estimated channel.

In a second aspect, alone or in combination with the first aspect, process 600 includes receiving an indication of at least one of a margin associated with the selected uplink beamforming codeword, or an SINR associated with the selected uplink beamforming codeword, wherein mapping the received indication of the standardized uplink codeword to the selected uplink beamforming codeword is further based at least in part on the at least one of the margin or the SINR.

In a third aspect, alone or in combination with one or more of the first and second aspects, the one or more CSI-RS resources are associated with multiple CSI-RS resource sets, each CSI-RS resource set, of the multiple CSI-RS resource sets, being associated with a different quantity of network node transmit ports, and process 600 includes transmitting, based at least in part on measuring the signals associated with the one or more CSI-RS resource sets, uplink feedback that indicates the selected uplink beamforming codeword and a corresponding CSI-RS resource set, of the multiple CSI-RS resource sets.

In a fourth aspect, alone or in combination with one or more of the first through third aspects, the uplink feedback indicates the selected uplink beamforming codeword by indicating an index associated with an uplink beamforming codebook, the uplink beamforming codebook being associated with multiple uplink beamforming sub-codebooks, each uplink beamforming sub-codebook corresponding to a different quantity of UE transmit ports, and each uplink beamforming sub-codebook, of the multiple uplink beamforming sub-codebooks, being associated with multiple candidate uplink beamforming codewords.

In a fifth aspect, alone or in combination with one or more of the first through fourth aspects, the one or more CSI-RS resources are associated with a single CSI-RS resource set, the single CSI-RS resource set being associated with a quantity of network node transmit ports, measuring the signals associated with the one or more CSI-RS resources includes measuring signals associated with one or more instances of the single CSI-RS resource set using, for each instance, of the one or more instances, a different quantity of ports that is less than or equal to the quantity of transmit ports, and process 600 includes transmitting, based at least in part on measuring the signals associated with the one or more instances of the single CSI-RS resource set, uplink feedback that indicates the selected uplink beamforming codeword.

In a sixth aspect, alone or in combination with one or more of the first through fifth aspects, process 600 includes receiving a subset indication associated with the single CSI-RS resource set that indicates a quantity that is less than or equal to the quantity of network node transmit ports, wherein a quantity of the one or more instances of the single CSI-RS resource set is greater than or equal to the quantity indicated by the subset indication and is less than or equal to the quantity of transmit ports.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a UE or an apparatus of a UE. Example process 700 is an example where the apparatus or the UE (e.g., UE 120) performs operations associated with reference signal resources and signaling for beamforming mode switching.

As shown in FIG. 7, in some aspects, process 700 may include receiving configuration information indicating: CSI-RS resources associated with a downlink beamforming mode switching capability of a network node, and multiple downlink beamforming modes, wherein each downlink beamforming mode, of the multiple downlink beamforming modes, is associated with a different subset of the CSI-RS resources (block 710). For example, the UE (e.g., using reception component 802 or communication manager 806, depicted in FIG. 8) may receive configuration information indicating: CSI-RS resources associated with a downlink beamforming mode switching capability of a network node, and multiple downlink beamforming modes, wherein each downlink beamforming mode, of the multiple downlink beamforming modes, is associated with a different subset of the CSI-RS resources, as described above.

As further shown in FIG. 7, in some aspects, process 700 may include transmitting one or more CSI reports based at least in part on measuring signals associated with the CSI-RS resources (block 720). For example, the UE (e.g., using transmission component 804 or communication manager 806, depicted in FIG. 8) may transmit one or more CSI reports based at least in part on measuring signals associated with the CSI-RS resources, as described above.

Process 700 may include additional aspects, such as any single aspect or any combination of aspects described below or in connection with one or more other processes described elsewhere herein.

In a first aspect, process 700 includes mapping each downlink beamforming mode, of the multiple downlink beamforming modes, to a respective subset of the CSI-RS resources.

In a second aspect, alone or in combination with the first aspect, the one or more CSI reports are based at least in part on applying a different CSI-RS power offset for each downlink beamforming mode.

In a third aspect, alone or in combination with one or more of the first and second aspects, the one or more CSI reports include a reference CSI report associated with a reference downlink beamforming mode, of the multiple downlink beamforming modes, and for each downlink beamforming mode, of the multiple downlink beamforming modes other than the reference downlink beamforming mode, a corresponding delta CSI report that is based at least in part on the reference CSI report.

In a fourth aspect, alone or in combination with one or more of the first through third aspects, the one or more CSI reports are based at least in part on one or more scheduling delay parameters associated with the multiple downlink beamforming modes.

In a fifth aspect, alone or in combination with one or more of the first through fourth aspects, the one or more CSI reports indicate one or more preferred downlink beamforming modes.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 4A-4E. Additionally, or alternatively, the apparatus 800 may be configured to perform one or more processes described herein, such as process 500 of FIG. 5, process 600 of FIG. 6, process 700 of FIG. 7, or a combination thereof. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive configuration information indicating one or more uplink reference signal resource groups associated with an uplink beamforming mode switching capability of the UE. The transmission component 804 may transmit one or more uplink reference signals based at least in part on the configuration information. The reception component 802 may receive feedback based at least in part on transmitting the one or more uplink reference signals. The reception component 802 or the transmission component 804 may communicate using a selected uplink beamforming mode that is based at least in part on the feedback.

The transmission component 804 may transmit an indication of a preferred uplink beamforming mode wherein receiving the feedback is further based at least in part on the indication of the preferred uplink beamforming mode.

The transmission component 804 may transmit capability information indicating an uplink beamforming mode switching capability of the UE. The reception component 802 may receive configuration information from a network node indicating one or more CSI-RS resources based at least in part on the capability information. The reception component 802 or the transmission component 804 may communicate using a selected uplink beamforming codeword that is based at least in part on measuring signals associated with the one or more CSI-RS resources.

The reception component 802 may receive an indication that the UE is to determine the selected uplink beamforming codeword.

The communication manager 806 may determine an estimated channel based at least in part on the one or more CSI-RS resources.

The communication manager 806 may determine the selected uplink beamforming codeword by mapping a received indication of a standardized uplink beamforming codeword to the selected uplink beamforming codeword based at least in part on the estimated channel.

The reception component 802 may receive an indication of at least one of a margin associated with the selected uplink beamforming codeword, or an SINR associated with the selected uplink beamforming codeword.

The reception component 802 may receive a subset indication associated with the single CSI-RS resource set that indicates a quantity that is less than or equal to the quantity of network node transmit ports.

The reception component 802 may receive configuration information indicating CSI-RS resources associated with a downlink beamforming mode switching capability of a network node, and multiple downlink beamforming modes, wherein each downlink beamforming mode, of the multiple downlink beamforming modes, is associated with a different subset of the CSI-RS resources. The transmission component 804 may transmit one or more CSI reports based at least in part on measuring signals associated with the CSI-RS resources.

The communication manager 806 may map each downlink beamforming mode, of the multiple downlink beamforming modes, to a respective subset of the CSI-RS resources.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of another example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 4A-4E. Additionally, or alternatively, the apparatus 900 may be configured to perform one or more processes described herein. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit configuration information indicating one or more uplink reference signal resource groups associated with an uplink beamforming mode switching capability of a UE. The reception component 902 may receive one or more uplink reference signals based at least in part on the configuration information. The transmission component 904 may transmit feedback based at least in part on transmitting the one or more uplink reference signals. The transmission component 904 or the reception component 902 may communicate using a selected uplink beamforming mode that is based at least in part on the feedback.

The reception component 902 may receive an indication of a preferred uplink beamforming mode.

The reception component 902 may receive capability information indicating an uplink beamforming mode switching capability of the UE. The transmission component 904 may transmit configuration information indicating one or more CSI-RS resources based at least in part on the capability information. The transmission component 904 or the reception component 902 may communicate using a selected uplink beamforming codeword that is based at least in part on measuring signals associated with the one or more CSI-RS resources.

The transmission component 904 may transmit an indication that the UE is to determine the selected uplink beamforming codeword.

The transmission component 904 may transmit an indication of at least one of a margin associated with the selected uplink beamforming codeword, or an SINR associated with the selected uplink beamforming codeword.

The transmission component 904 may transmit a subset indication associated with the single CSI-RS resource set that indicates a quantity that is less than or equal to the quantity of network node transmit ports.

The transmission component 904 may transmit configuration information indicating CSI-RS resources associated with a downlink beamforming mode switching capability of a network node, and multiple downlink beamforming modes, wherein each downlink beamforming mode, of the multiple downlink beamforming modes, is associated with a different subset of the CSI-RS resources. The reception component 902 may receive one or more CSI reports based at least in part on measuring signals associated with the CSI-RS resources.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving configuration information indicating one or more uplink reference signal resource groups associated with an uplink beamforming mode switching capability of the UE; transmitting one or more uplink reference signals based at least in part on the configuration information; receiving feedback based at least in part on transmitting the one or more uplink reference signals; and communicating using a selected uplink beamforming mode that is based at least in part on the feedback.

Aspect 2: The method of Aspect 1, wherein each uplink reference signal resource group, of the one or more uplink reference signal resource groups, is associated with one of: a respective subset of resources of a sounding reference signal (SRS) resource set, or a respective SRS resource set.

Aspect 3: The method of any of Aspects 1-2, wherein receiving the feedback includes receiving an indication of the selected uplink beamforming mode.

Aspect 4: The method of Aspect 3, wherein the indication of the selected uplink beamforming mode is associated with one of: a resource group indication field of an uplink scheduling downlink control information (DCI) communication, or a sounding reference signal resource indication field of the uplink scheduling DCI communication.

Aspect 5: The method of Aspect 4, wherein the uplink scheduling DCI communication indicates a scheduling offset associated with an uplink communication, and wherein the scheduling offset is greater than or equal to a minimum mode switching delay associated with the selected uplink beamforming mode.

Aspect 6: The method of any of Aspects 1-5, further comprising transmitting an indication of a preferred uplink beamforming mode, wherein receiving the feedback is further based at least in part on the indication of the preferred uplink beamforming mode.

Aspect 7: The method of Aspect 6, wherein the feedback is associated with at least one of: a delay after transmitting the indication of the preferred uplink beamforming mode satisfying a threshold, or reception of an acknowledgement message associated with the indication of the preferred uplink beamforming mode.

Aspect 8: A method of wireless communication performed by a user equipment (UE), comprising: transmitting capability information indicating an uplink beamforming mode switching capability of the UE; receiving configuration information from a network node indicating one or more channel state information reference signal (CSI-RS) resources based at least in part on the capability information; and communicating using a selected uplink beamforming codeword that is based at least in part on measuring signals associated with the one or more CSI-RS resources.

Aspect 9: The method of Aspect 8, further comprising: receiving an indication that the UE is to determine the selected uplink beamforming codeword; determining an estimated channel based at least in part on the one or more CSI-RS resources; and determining the selected uplink beamforming codeword by mapping a received indication of a standardized uplink beamforming codeword to the selected uplink beamforming codeword based at least in part on the estimated channel.

Aspect 10: The method of Aspect 9, further comprising receiving an indication of at least one of a margin associated with the selected uplink beamforming codeword, or a signal-to-interference-plus-noise ratio (SINR) associated with the selected uplink beamforming codeword, wherein mapping the received indication of the standardized uplink codeword to the selected uplink beamforming codeword is further based at least in part on the at least one of the margin or the SINR.

Aspect 11: The method of any of Aspects 8-10, wherein the one or more CSI-RS resources are associated with multiple CSI-RS resource sets, each CSI-RS resource set, of the multiple CSI-RS resource sets, being associated with a different quantity of network node transmit ports, and wherein the method comprises transmitting, based at least in part on measuring the signals associated with the one or more CSI-RS resource sets, uplink feedback that indicates the selected uplink beamforming codeword and a corresponding CSI-RS resource set, of the multiple CSI-RS resource sets.

Aspect 12: The method of Aspect 11, wherein the uplink feedback indicates the selected uplink beamforming codeword by indicating an index associated with an uplink beamforming codebook, wherein the uplink beamforming codebook is associated with multiple uplink beamforming sub-codebooks, each uplink beamforming sub-codebook corresponding to a different quantity of UE transmit ports, and wherein each uplink beamforming sub-codebook, of the multiple uplink beamforming sub-codebooks, is associated with multiple candidate uplink beamforming codewords.

Aspect 13: The method of any of Aspects 8-12, wherein the one or more CSI-RS resources are associated with a single CSI-RS resource set, the single CSI-RS resource set being associated with a quantity of network node transmit ports, wherein measuring the signals associated with the one or more CSI-RS resources includes measuring signals associated with one or more instances of the single CSI-RS resource set using, for each instance, of the one or more instances, a different quantity of ports that is less than or equal to the quantity of transmit ports, and wherein the method further comprises transmitting, based at least in part on measuring the signals associated with the one or more instances of the single CSI-RS resource set, uplink feedback that indicates the selected uplink beamforming codeword.

Aspect 14: The method of Aspect 13, further comprising receiving a subset indication associated with the single CSI-RS resource set that indicates a quantity that is less than or equal to the quantity of network node transmit ports, wherein a quantity of the one or more instances of the single CSI-RS resource set is greater than or equal to the quantity indicated by the subset indication and is less than or equal to the quantity of transmit ports.

Aspect 15: A method of wireless communication performed by a user equipment (UE), comprising: receiving configuration information indicating: channel state information (CSI) reference signal (CSI-RS) resources associated with a downlink beamforming mode switching capability of a network node, and multiple downlink beamforming modes, wherein each downlink beamforming mode, of the multiple downlink beamforming modes, is associated with a different subset of the CSI-RS resources; and transmitting one or more CSI reports based at least in part on measuring signals associated with the CSI-RS resources.

Aspect 16: The method of Aspect 15, further comprising mapping each downlink beamforming mode, of the multiple downlink beamforming modes, to a respective subset of the CSI-RS resources.

Aspect 17: The method of any of Aspects 15-16, wherein the one or more CSI reports are based at least in part on applying a different CSI-RS power offset for each downlink beamforming mode.

Aspect 18: The method of any of Aspects 15-17, wherein the one or more CSI reports include: a reference CSI report associated with a reference downlink beamforming mode, of the multiple downlink beamforming modes, and for each downlink beamforming mode, of the multiple downlink beamforming modes other than the reference downlink beamforming mode, a corresponding delta CSI report that is based at least in part on the reference CSI report.

Aspect 19: The method of any of Aspects 15-18, wherein the one or more CSI reports are based at least in part on one or more scheduling delay parameters associated with the multiple downlink beamforming modes.

Aspect 20: The method of any of Aspects 15-19, wherein the one or more CSI reports indicate one or more preferred downlink beamforming modes.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

Aspect 28: A device comprising a processing system that includes one or more processors and one or more code-storing memories coupled with the one or more processors, the processing system configured to cause the device to perform the method of one or more of Aspects 1-20.

Aspect 29: A device comprising a processing system that includes processor circuitry and code-storing memory circuitry, the processing system configured to cause the device to perform the method of one or more of Aspects 1-20.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive configuration information indicating one or more uplink reference signal resource groups associated with an uplink beamforming mode switching capability of the UE;
transmit one or more uplink reference signals based at least in part on the configuration information;
receive feedback based at least in part on transmitting the one or more uplink reference signals; and
communicate using a selected uplink beamforming mode that is based at least in part on the feedback.

2. The UE of claim 1, wherein each uplink reference signal resource group, of the one or more uplink reference signal resource groups, is associated with one of:
a respective subset of resources of a sounding reference signal (SRS) resource set, or
a respective SRS resource set.

3. The UE of claim 1, wherein the processing system, to cause the UE to receive the feedback, is configured to cause the UE to receive an indication of the selected uplink beamforming mode.

4. The UE of claim 3, wherein the indication of the selected uplink beamforming mode is associated with one of:
a resource group indication field of an uplink scheduling downlink control information (DCI) communication, or
a sounding reference signal resource indication field of the uplink scheduling DCI communication.

5. The UE of claim 4, wherein the uplink scheduling DCI communication indicates a scheduling offset associated with an uplink communication, and
wherein the scheduling offset is greater than or equal to a minimum mode switching delay associated with the selected uplink beamforming mode.

6. The UE of claim 1, wherein the processing system is configured to cause the UE to transmit an indication of a preferred uplink beamforming mode, and
wherein the processing system, to cause the UE to receive the feedback, is configured to cause the UE to receive the feedback based at least in part on the indication of the preferred uplink beamforming mode.

7. The UE of claim 6, wherein the feedback is associated with at least one of:
a delay after transmitting the indication of the preferred uplink beamforming mode satisfying a threshold, or
reception of an acknowledgement message associated with the indication of the preferred uplink beamforming mode.

8. A user equipment (UE), comprising:
a processing system that includes one or more processors and one or more code-storing memories coupled with the one or more processors, the processing system configured to cause the UE to:
transmit capability information indicating an uplink beamforming mode switching capability of the UE;
receive configuration information from a network node indicating one or more channel state information reference signal (CSI-RS) resources based at least in part on the capability information; and
communicate using a selected uplink beamforming codeword that is based at least in part on measuring signals associated with the one or more CSI-RS resources.

9. The UE of claim 8, wherein the processing system is configured to cause the UE to:
receive an indication that the UE is to determine the selected uplink beamforming codeword;
determine an estimated channel based at least in part on the one or more CSI-RS resources; and
determine the selected uplink beamforming codeword by mapping a received indication of a standardized uplink beamforming codeword to the selected uplink beamforming codeword based at least in part on the estimated channel.

10. The UE of claim 9, wherein the processing system is configured to cause the UE to receive an indication of at least one of a margin associated with the selected uplink beamforming codeword, or a signal-to-interference-plus-noise ratio (SINR) associated with the selected uplink beamforming codeword, and
wherein the processing system, to cause the UE to map the received indication of the standardized uplink codeword to the selected uplink beamforming codeword, is configured to cause the UE to map the received indication of the standardized uplink codeword to the selected uplink beamforming codeword based at least in part on the at least one of the margin or the SINR.

11. The UE of claim 8, wherein the one or more CSI-RS resources are associated with multiple CSI-RS resource sets, each CSI-RS resource set, of the multiple CSI-RS resource sets, being associated with a different quantity of network node transmit ports, and
wherein processing system is configured to cause the UE to transmit, based at least in part on measuring the signals associated with the one or more CSI-RS resource sets, uplink feedback that indicates the selected uplink beamforming codeword and a corresponding CSI-RS resource set, of the multiple CSI-RS resource sets.

12. The UE of claim 11, wherein the uplink feedback indicates the selected uplink beamforming codeword by indicating an index associated with an uplink beamforming codebook,
wherein the uplink beamforming codebook is associated with multiple uplink beamforming sub-codebooks, each uplink beamforming sub-codebook corresponding to a different quantity of UE transmit ports, and
wherein each uplink beamforming sub-codebook, of the multiple uplink beamforming sub-codebooks, is associated with multiple candidate uplink beamforming codewords.

13. The UE of claim 8, wherein the one or more CSI-RS resources are associated with a single CSI-RS resource set, the single CSI-RS resource set being associated with a quantity of network node transmit ports,
wherein the processing system, to cause the UE to measure the signals associated with the one or more CSI-RS resources, is configured to cause the UE to measure signals associated with one or more instances of the single CSI-RS resource set using, for each instance, of the one or more instances, a different quantity of ports that is less than or equal to the quantity of transmit ports, and
wherein the processing system is configured to cause the UE to transmit, based at least in part on measuring the signals associated with the one or more instances of the single CSI-RS resource set, uplink feedback that indicates the selected uplink beamforming codeword.

14. The UE of claim 13, wherein the processing system is configured to cause the UE to receive a subset indication associated with the single CSI-RS resource set that indicates a quantity that is less than or equal to the quantity of network node transmit ports,
wherein a quantity of the one or more instances of the single CSI-RS resource set is greater than or equal to the quantity indicated by the subset indication and is less than or equal to the quantity of transmit ports.

15. A user equipment (UE), comprising:
a processing system that includes one or more processors and one or more code-storing memories coupled with the one or more processors, the processing system configured to cause the UE to:
receive configuration information indicating:
channel state information (CSI) reference signal (CSI-RS) resources associated with a downlink beamforming mode switching capability of a network node, and
multiple downlink beamforming modes, wherein each downlink beamforming mode, of the multiple downlink beamforming modes, is associated with a different subset of the CSI-RS resources; and
transmit one or more CSI reports based at least in part on measuring signals associated with the CSI-RS resources.

16. The UE of claim 15, wherein the processing system is configured to cause the UE to map each downlink beamforming mode, of the multiple downlink beamforming modes, to a respective subset of the CSI-RS resources.

17. The UE of claim 15, wherein the one or more CSI reports are based at least in part on applying a different CSI-RS power offset for each downlink beamforming mode.

18. The UE of claim 15, wherein the one or more CSI reports include:
a reference CSI report associated with a reference downlink beamforming mode, of the multiple downlink beamforming modes, and
for each downlink beamforming mode, of the multiple downlink beamforming modes other than the reference downlink beamforming mode, a corresponding delta CSI report that is based at least in part on the reference CSI report.

19. The UE of claim 15, wherein the one or more CSI reports are based at least in part on one or more scheduling delay parameters associated with the multiple downlink beamforming modes.

20. The UE of claim 15, wherein the one or more CSI reports indicate one or more preferred downlink beamforming modes.
